(19) United States
(12) Patent Application Publication
(10) Pub. No.: US 2011/0275354 A1
(43) Pub. Date: Nov. 10, 2011

(54) PERSONAL COMPANION

(76) Inventor: PERVEZ AKHTER, SAYREVILLE, NJ (US)

(21) Appl. No.: 13/100,049

(22) Filed: May 3, 2011

Related U.S. Application Data
(60) Provisional application No. 61/365,832, filed on Jul. 20, 2010.
(60) Provisional application No. 61/330,981, filed on May 4, 2010.

(51) Int. Cl. H04W 4/00

(52) U.S. Cl. 455/414.1

(57) ABSTRACT

A method of advertizing using a device called Personal Companion. The Personal Companion is a specially designed device or existing Smart Phone linked to cloud based servers via Communication Careers. The device and other enabling gadgets and services are distributed free of charge to members of the public in return for a continuous, uninterruptible flow of consented advertisements. Watching these adverts will typically result in compensation accruing to the user. Users may, however, opt to stop flow of ad, but may forfeit that compensation. The ad server distributes marketing data to the device based on it's physical location, amongst other factors. Preferably, the geographical coordinates of the navigation device are fed to the ad server, which then returns advertisements from businesses operating within those coordinates. The navigation device receives and outputs navigational or entertainment information, in conjunction with marketing data.

### CLAIM OF PRIORITY

This application claims priority to U.S. Provisional Patent Application No. 61/330,098 filed on May 4, 2010, and to U.S. Provisional Patent Application No. 61/365,832 filed on Jul. 20, 2010, the contents of both of which are hereby fully incorporated herein by reference.

### FIELD OF THE INVENTION

The invention relates to a system and method for providing rewards to smart phone users, and more particularly, to rewarding smart phone users via sharing proceeds from advertising, charitable donations and carbon credits etc.

The advertising method may utilize a Handheld Computing Device such as, but not limited to, a Smart Phone or similar device suitably enabled for user interaction with delivered content, such as, but not limited to, an Interactive TV or a display for a web browser, that may be used to obtain public attention to a message by means of a network such as, but not limited to, an Internet Connection or other electronic medium that can be used to get public attention to one or more conveyed messages. Messages may be acknowledged and the public may be compensated for paying attention to the messages and advertisers may see the value added and be willing to pay the general public viewing the adverts as well as the company providing the advertising platform.

### BACKGROUND OF THE INVENTION

Note: Throughout this document, the words ‘UH’, ‘UHO’, ‘TCC’ are intended to interchangeably mean ‘The Company Who Will Sponsor the Invention’. This may, for instance, be any entity that may own the invention at the time of the product launch

The invention relates to a novel marketing method that is enabled by a system and method for providing rewards to smart phone users. The invention also relates to a combination of devices that implement this marketing method.

In particular, the novel marketing method may utilize handheld devices, such as, but not limited to, a Smart Phone, an iPad, an Interactive TV, a display for a Web Browser or an iPhone etc. The handheld devices may also be equipped to function as global positioning systems (GPS), providing further useful ways that may help pay for the upfront cost and maintenance of the device as well as other attachments or applications that may enable the general public to respond to general or targeted commercial messages. The handheld device, which may also be called a Personal Companion, may be well suited for displaying promotional messages as it may interactively attract the focus of The User, or vehicle occupants, who may be using the handheld device for general computing needs such as, but not limited to, finding directions. The handheld device, or personal companion, may be used in many other innovative ways to attract and retain the attention of the user, thereby making it a suitable place to advertise. The device may be used in many innovative ways that may help pay for the device, its maintenance and for other attachable gadgets, thereby enabling it to be given to general public for free, in return for using the device in natural everyday situations as well as for earning points, or other remuneration, for watching advertisements. The handheld device may also be used for other activities discussed in detail later in the document. Note: All thorough the document words ‘UH’, ‘UHO’, ‘TCC’ are used interchangeably to mean ‘The Company Who Will Sponsor the Invention’ It may be any entity that may own the invention at the time of the product launch

GPS devices and Smart Phones are well known in the art, and their functionality has been widely developed. However, the marketing industry does not yet utilize them in a significant way, due in large part to their being used by only a small fraction of the global population because existing technology is too expensive to be afforded by the average person, especially in underdeveloped or developing countries.

Until now, subscription to promotional or informational data has been almost exclusively voluntary with little or no participation incentives for the receiver. Therefore, marketers largely ignored this informational niche. The system of the present invention removes a large portion of user discretion in exchange for free device, a reimbursement for a purchased device or free services. However, the user may take back some of the control by paying the full or in part for the device rather than opting to watch the advertisements. The subscription to marketing data and user's participation may be managed centrally, which may also enable such novel and useful features as remote device control and location, passive usage monitoring, active preference gathering, the ability to cast votes and the ability to use the device for functions such as, but not limited to, a Passport, a Driver's License or a Census Input Provider. Such uses may result in significant energy and cost savings.

### DESCRIPTION OF THE RELATED ART

US Patent Application No. 20090204484 describes a system for displaying targeted digital electronic advertising on mobile display systems based upon GPS coordinates and demographic data correlated to those GPS coordinates and current time. The display can “intelligently” download and project relevant and targeted advertising based upon (1) the displays known location, (2) current time, and (3) demographic data of people known to share the display's location at that time. Displayed content can thereby change in a dynamic fashion and with relatively unlimited frequency. Advertising content and demographic data can be stored local to the display device (“onboard”) or obtained in real time using any number of wireless networking technologies as the display moves through space and time. Further, total display times of a given advertisement can be calculated and stored as means to determine advertising fees.

US Patent Application No. 20090006194 described a technology by which an advertisement is selected for output on a mobile (e.g., vehicle navigation) system based on contextual data, including current state data from a location-sensing (e.g., GPS) device. The advertisement may be an image displayed at a location on a map corresponding to a physical location of the advertiser. The contextual data may include location, direction and destination data, user preference data and user-provided data such as calendar, task and/or contacts data. Examples of other contextual data include age data, gender data, number of vehicle occupants data, vehicle make data, vehicle model data, and/or vehicle style data. In one aspect, the user may interact with the advertisement, e.g., to communicate an order for a product or service corresponding to the advertisement.

Various implements are known in the art, but fail to address all of the problems solved by the invention described herein. One embodiment of this invention is illustrated in the accompanying drawings and will be described in more detail herein below.

### SUMMARY OF THE INVENTION

The invention discloses a system and method for providing rewards to smart phone users by sharing with them proceeds from sources such as, but not limited to, advertising, charitable donations and carbon credits, in return for their participation in various activities, such as, but not limited to, viewing advertisements.

The advertising may be delivered to the user by means of a suitably programmed hand held computing device, also known as a Personal Companion. The Personal Companion may also include a computerized navigation module, a camera and it may be linked to an ad server. The device is preferably distributed to members of the public free of charge in return for a continuous, but not mandatory, flow of advertisements.

Users may, however, have the option to stop the flow of ads if they so desire. The ad server may distribute marketing data to the hand held computing device based on factors such as, but not limited to, weather, the time of day, a user's mood, a user's personal interests, the prevailing economic conditions, prevailing social and political factors and also on the physical location of the hand held computing device at the time the marketing data is distributed, and on events, structures or people in a vicinity of the current location of the hand held computing device.

The geographical coordinates of the navigation device may, for instance, be fed back to the ad server, which may then return advertisements from businesses operating within a predetermined vicinity of those coordinates. The hand held computing device may receive and output navigational or entertainment information in conjunction with the marketing data.

Therefore, the present invention succeeds in conferring the following, and others not mentioned, desirable and useful benefits and objectives.

It is an object of the present invention to open a new advertizing venue for merchants in USA and across the globe as needed, while providing a free Electronic Device for consumers.

It is an object of the present invention to provide a Free Device, besides other numerous advantages that today's technologies offer that can serve as an information and entertainment center as well as huge positive environmental impacts and energy savings that were not possible due to inability of general public to afford such a versatile gadget.

It is another object of the present invention to provide a navigation device capable of supplying marketing and Business Intelligence data for and from merchants based on the physical location of the device.

Still another object of the present invention is to provide an electronic device that is capable of storing all data locally.

Still another object of the present invention is to provide an electronic device capable of communicating with a central ad service as well as with government databases in all countries for huge public benefits.

Yet another object of the present invention is to provide an electronic device that is capable of communicating with orbiting satellites.

Still another object of the present invention is to provide an electronic device that is capable of providing walking directions, driving directions, hiking directions of navigation for a variety of other transit means.

It is another object of the present invention is to provide the largest conceivable implementation of a central server; including but not limited to, IBM Websphere Application Server and relevant utilities like Ecommerce etc.

Still another object of the present invention is to provide the largest possible network of IP connected devices talking to the central server installed and maintained by a service entity; including but not limited to, IBM, Google or Microsoft.

Still another object of the present invention is to provide the largest collection of data that can be used to monitor human behavior globally using Business Intelligence tools.

### BRIEF DESCRIPTION OF THE DRAWINGS

FIG. 1 is a flowchart of the preferred embodiment of the advertizing method.

FIG. 2 is a flow chart of advertising points scoring method, that eventually enable free distribution of the device

FIG. 3 is a flowchart that demonstrates the method of utilizing a navigation device that enables the claimed advertizing method.

FIG. 4 is a flow chart that demonstrates the coupon distribution method

FIG. 5 is a schematic representation of the United Humanity Organization (UHO).

FIG. 6 illustrates Flow Chart outlining a UH Wake-Up Alarm Application Method.

FIG. 7 illustrates Flow Chart outlining UH Surveys Method

FIG. 8 illustrates a Flow Chart Outlining UH Product Catalogs Method.

FIG. 9 illustrates Flow Chart outlining UH Opinion Polls Method

FIG. 10 illustrates Flow Chart outlining UH Movies Method:

FIG. 11 illustrates Flow Chart outlining Loyalty Cards Method

FIG. 12 illustrates Flow Chart of UH Job Portal Method

FIG. 13 illustrates Flow Chart of UH GPS Method

FIG. 14 illustrates Flow Chart of UH Email Method

FIG. 15 illustrates Flow Chart of Credit CardMethod

FIG. 16 illustrates Flow Chart of UH Commercial Pages Method

FIG. 17 illustrates Flow Chart of Blood Donation Method

FIG. 18 illustrates a second part of a Flow Chart of Blood Donation Method

FIG. 19 illustrates a third part of a Flow Chart of Blood Donation Method

FIG. 20 illustrates Flow Chart of World Wide Democracy App Method

FIG. 21 illustrates Flow Chart of UH TV App Method

FIG. 22 illustrates Flow Chart of UH Signup App Method

FIG. 23 illustrates Flow Chart of UH Electronic Passport App Method

FIG. 24 illustrates Flow Chart of UH NCLB (No Child Left Behind) App Method

FIG. 25 illustrates Flow Chart of Mass Bargain App Method

FIG. 26 illustrates Flow Chart of Libraries App Method

FIG. 27 illustrates Flow Chart of Libraries App Method

FIG. 28 illustrates Flow Chart of Free Food App Method

FIG. 29 illustrates Flow Chart of Driver's License App Method

FIG. 30 illustrates Flow Chart of Compliance App Method

FIG. 31 illustrates Flow Chart of Census App Method

FIG. 33 illustrates Flow Chart of UH Social Network App Method

FIG. 34 illustrates Flow Chart of UH Planned Parenthood App Method

FIG. 35 illustrates Flow Chart of UH Newspapers and Magazines App Method

FIG. 36 illustrates Flow Chart of UH Matrimonial App Method

FIG. 37 illustrates Flow Chart of UH Literacy App Method

FIG. 38 illustrates Flow Chart of UH Medical History App Method

FIG. 39 illustrates Flow Chart of UH Give Aways App Method

FIG. 40 illustrates Flow Chart of UH Elections App Method

FIG. 41 illustrates Flow Chart of UH Classified Ads App Method

FIG. 42 illustrates Flow Chart of UH BLOG App Method

FIG. 43 illustrates and explains UH LOGO

FIG. 44 illustrates and explains UH Web Site

FIG. 45 illustrates Flow Chart of UH App Store Method

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

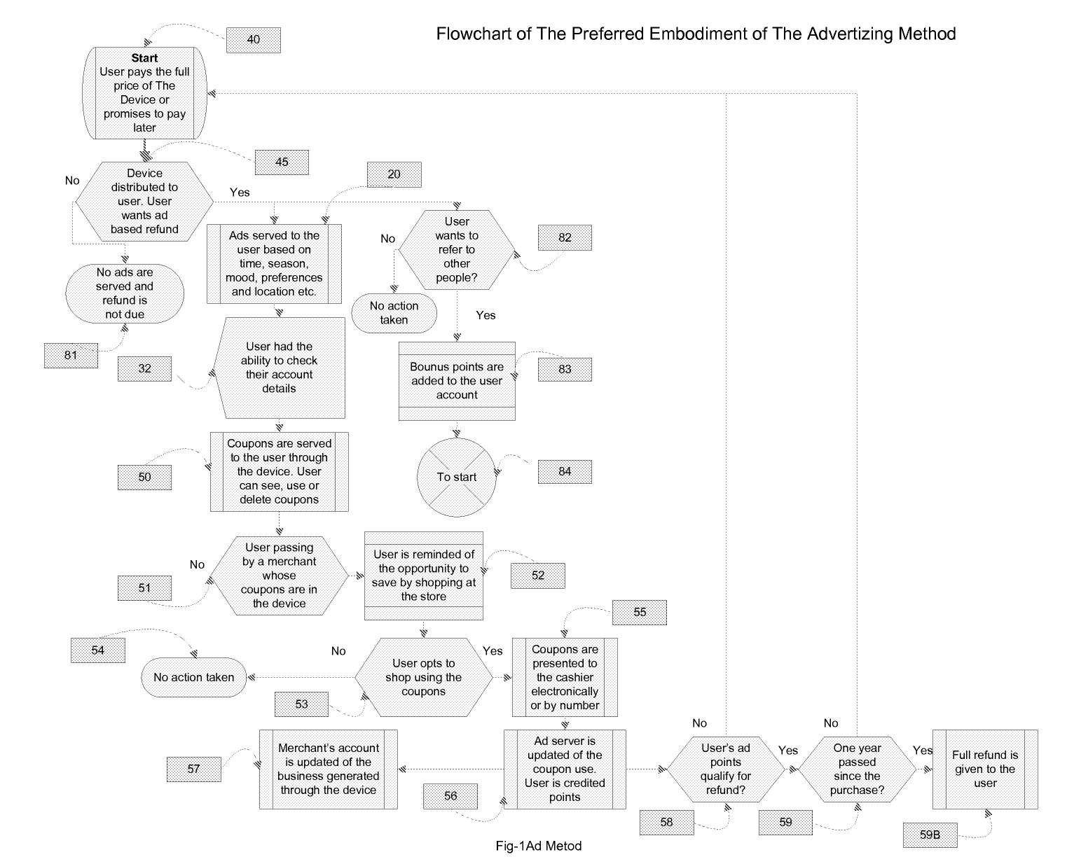

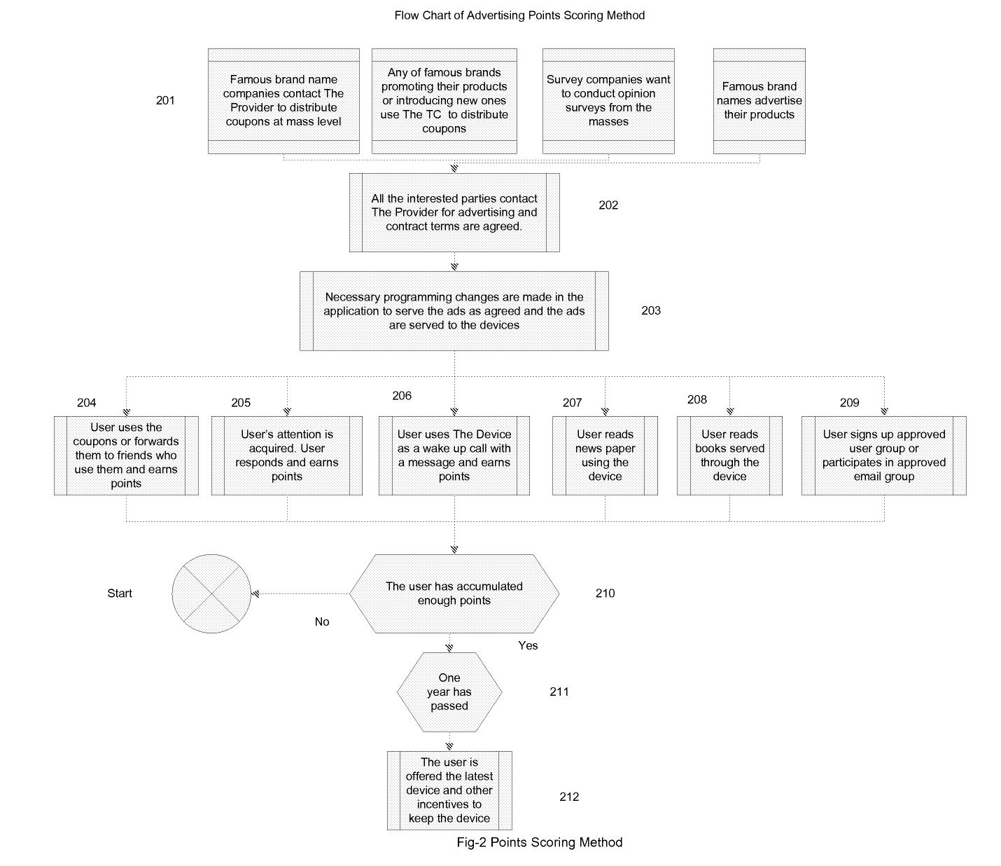

FIGS. 1 and 2 illustrate the steps of the claimed marketing method. The Personal Companion, also known as the navigation device (ND), may be linked to an ad server in step 20. The ad server is preferably centrally located and may include a single computer server or a plurality of computer servers. One skilled in the art will appreciate that such an ad server may communicate with an ND using a wireless Internet protocol, which may require the use of a satellite link The server or servers may run any commercially available operating systems such as, but not limited to, “Windows”, “Unix”, or “Linux.” Such an ad server may, for instance, be managed by a Personal Companion company (PCC), which may solicit and receive marketing data from merchants and send this data in form of advertisements and promotions to the subscribing NDs 120. A Personal Companion Company, also called UH or UHO, may also utilize the ad servers or a specialized receiving server to track whether a user of the smart phone/ND 120 is utilizing the device 120 and the marketing data that it receives or contains.

Alternatively, the linking step 20 may be accomplished using portable memory devices. The portable memory device may, for instance, contain marketing data in a format that may be readable by an ND 120. Presently, NDs are typically preloaded with road maps. These maps may be updated through portable memory devices. The present invention may supplement the map or navigational data with marketing data, which may be displayed or announced to the user at appropriate time intervals, or when the user is within the vicinity of the advertizing merchant. The smart phone/ND 120 may keep track of the usage of the marketing data by the user and may prompt the user at predefined intervals to exchange the portable memory device for an updated version. The PCC may then keep track of the marketing data usage by reading the information on the portable memory device that was returned by the user of the smart phone/ND. Such monitoring may also occur over a specific period of time, for example over the course of a year.

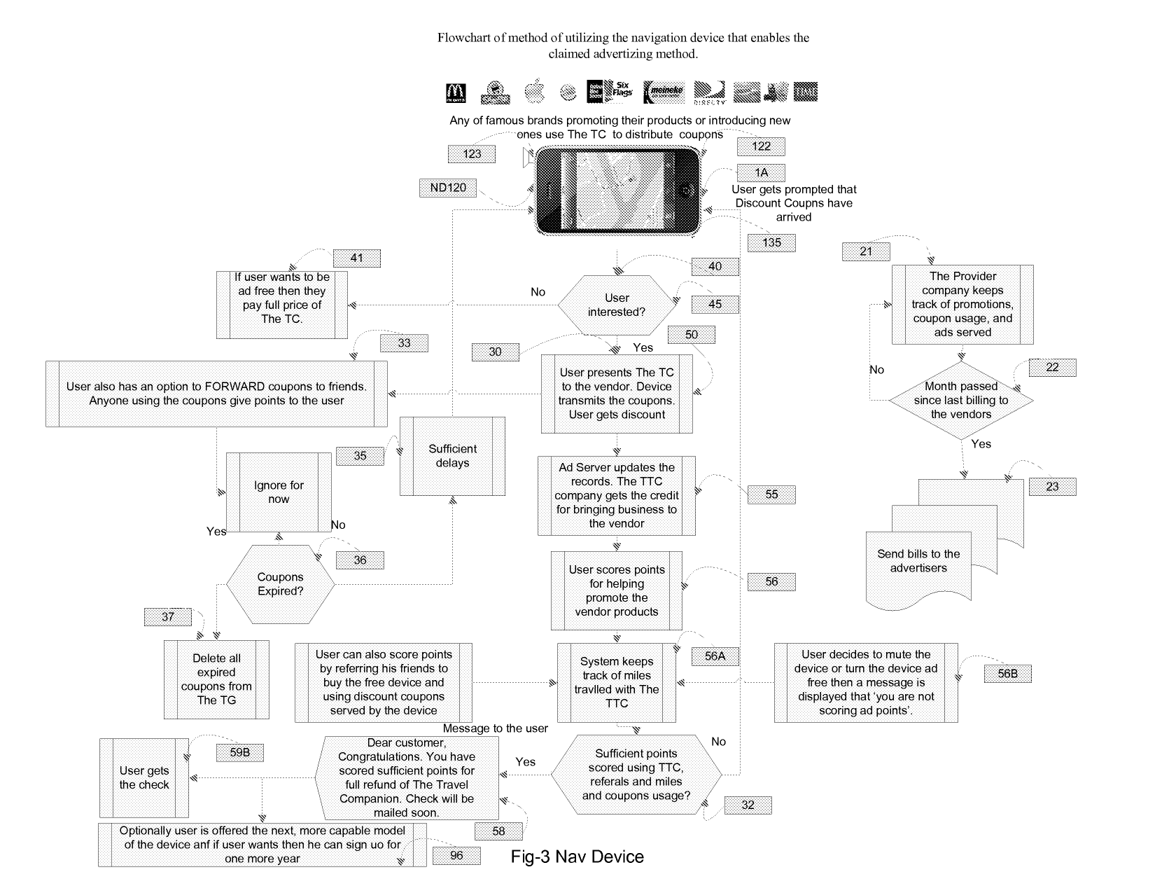

In step 40 the smart phone/ND may be distributed to users. The smart phone/ND 102 (FIG. 3) may be distributed to users free of charge, provided that users agree to preconditions such as, but not limited to, to receive marketing data in the form of coupons and other promotional materials. Note that a user may first acquire the device for its retail price (FIG. 2) and may later choose to participate in the method embodied by the invention, by, for instance, subscribing to the marketing data.

The user may consent to receive marketing data in step 40. The consent may be implied through the user's receiving of the smart phone/ND from the PCC or the UH and subsequently using it. The consent may be expressly solicited by displaying messages on the smart phone/ND or through another means such as telephone, e-mail, interactive web-site or postal communication. If a user declines to receive the marketing data, then he or she may be required to pay for the smart phone/ND, return it to the PCC, or receive no credit for a prior purchase of the smart phone/ND as illustrated in step 41.

The marketing data distributed to an ND 120 can preferably be traced back to each individual ND through use of serial numbers or other unique identifiers. The purpose of tracking marketing data may be to enable the ad server or the PCC to track marketing data usage and run business intelligence reports by each individual ND 120. Thus, if a usage level is consistent with a subscription agreement between the PCC and the user, a refund may be issued for the smart phone/ND 120 after a prescribed period of time, or the user's obligation to pay for the distributed device may be waived.

The marketing data may be distributed to the navigation device in step 30. The distribution is based on the physical location of the particular ND 120 and other determining factors such as, but not limited to, a user's taste or buying habits. For example, if user “A” is traveling along interstate “1”, A's ND 120 may receive a pop-up or an audio message containing promotional information or coupons from any merchant within a predetermined distance, for instance within a ten mile radius of user “A” current location. Any distance may be specified, however, a distance that may be easily reached within several minutes of travel may be preferred by the merchants, who can also specify their desired target region. The advertisements may be stored centrally on an ad server or locally on the smart phone/ND. A merchant may be able to select which users should be targeted. For example, a local auto parts store may wish to only target parts delivery services or mechanics, while an upscale restaurant may only wish to target consumers of certain age, income level, or make and year of their vehicles. All this information may be stored on the smart phone/ND or managed centrally by the ad server. The smart phone/ND 120 is preferably capable of altering navigational directions by adding detours and alternative routes, if the user chooses to follow up on the displayed promotion (step 55).

Marketing data received by the smart phone/ND 120 may then outputted along with all navigational or entertainment data in step 50. The output may occur in form of a popup, as illustrated in FIG. 3 step 1A, or over an audio device on the smart phone/ND 120. The smart phone/ND 120 may have a connection with the audio system of a user's vehicle, in which case, marketing and navigational data may be broadcasted by using the vehicle's speakers. One skilled in the art will appreciate that navigational data may be substituted with entertainment data such as, but not limited to video games, movies, tour guide presentations, news services, lectures etc. The smart phone/ND 120 may be equipped with an ability to access the Internet, in which case the marketing data may be displayed based on websites visited by the user or based on the user's pattern of interest in ads.

The outputting of the marketing data on the smart phone/ND in step FIG. 1 step 50 may include additional steps illustrated in FIG. 1, as well as other tasks not specifically detailed herein. In step 51 the device or the ad server may continuously, or quasi-continuously, poll the physical coordinates of the smart phone/ND. The coordinates may be compared against the marketing data on the ad server or on the smart phone/ND to determine whether any merchants are within a predetermined range of the user's device 120. If any such merchants are found, their advertisements and coupons may be displayed in step 52. If more than one merchant is found, their coupons may cycle and may be recalled by the user from memory cache as desired. The advertisement may be presented repeatedly as the smart phone/ND travels closer or further away from the advertizing merchant. In step 53 the user may utilize the coupons when shopping or acquiring advertized produces or services. The smart phone/ND 120 may be able to accept interactive user input using voice recognition technology, by utilizing a touch screen, or any other type of input device. Such an embodiment enables presentation of the coupons electronically in step 55. Step 55 also incorporates other possible actions by the user such as, but not limited to, placing orders or reservations directly from the smart phone/ND 120. The user may use the coupons by directly interacting with a merchant's point of sale system, or by presenting the displayed coupon to a merchant using a numbering or codified tracking identifier. This makes the device very attractive to the user as they do not have to shuffle through the bunch of coupons. Many such identifiers are widely used in the art and their variations will be appreciated by one skilled in the art. The user may chose to ignore the coupon in step 54, in which case the user may or may not get any credit for viewing the advertisement.

Step 55 leads to step 56, where the ad server (PCC) or the smart phone/ND may track the usage of the marketing data on the smart phone/ND. The usage may, for instance, be tracked using a system such as, but not limited to, a point system, a distance traveled to redeem the coupons, or by dollar value of the actions taken in step 55 or a combination thereof. The user may receive periodic updates of his or her usage progress in step 32. Additionally, the advertizing merchant may be billed by PCC in step 57 for the usage activity that occurred in step 55.

The user may receive points for referring other users to the PCC provider in step FIG. 1-82. To qualify for points, the user may refer other users of GPS devices to an ad server (PCC). If these users agree to subscribe to marketing information, the referring user will receive a credit in form of bonus points in FIG. 1 step 83, a dollar figure, or a credit toward the value of the received device.

In FIG. 1 step 58 the user's points may be periodically tallied or the subscription may be evaluated at the end of a prescribed period in FIG. 1 step 59. If the user purchased the device in step 40 (FIG. 1) then the user may receive credit for adequate usage in of the marketing data in step 59B or may have to continue to score points as usual.

The purchased ND may not initially be linked to an ad service. However, the user may wish to recoup the funds expanded in purchasing the smart phone/ND in FIG. 1 step 80. Such a user may have a choice of agreeing to receive a distribution of the marketing data in FIG. 3 step 30 or referring other users to the ad server in FIG. 1 step 82. To enable FIG. 3 step 30, the marketing data may be made compatible with most known ND types by, for instance installing a compatibility module on the smart phone/ND. The ad server may also be capable of supporting a range of ND models. One will also appreciate that for the purposes of the present invention, the term ND may apply to other personal electronic devices such as, but not limited to telephones, pocket organizers, and mini-entertainment devices such as an iPod® device.

If a user fails to meet usage expectations over a specified period of time, they may, at the discretion of the NCC, receive no credit, or an incomplete refund, as detailed in FIG. 1 step 59B. The user may also decline a subscription and not refer any other users to the ad server, in which case they may be issued no credit in FIG. 1 step 81.

FIG. 3 describes the same navigation device 120 (ND). The smart phone/ND 120 preferably has a display component 122, a built-in audio component 123 and at least one connectivity interface 135. The display component 122 may, for instance, be a speaker having a width in a range of approximately two to four inches. The display component 122 may also have wide screen with a touch enabled capability. The audio component 123 may be a speaker included with the smart phone/ND 120 or may be a separately attached speaker, head phones or a vehicle's audio system. The connectivity interface 135 may be a wireless antenna for connecting to an ad server, to an orbiting satellite or to both. The connection to the ad server may be accomplished over the internet or through a private network. A private connection may also be established over the public internet though the use of tunneling protocols and encryption.

The ad server in FIG. 3 step 21, also known as a Personal Companion company (PCC or UH), may communicate with the device in FIG. 1 step 20. The communication may be for uploading marketing data unto the smart phone/ND FIG. 3, 120, or for retrieving the physical coordinates of the smart phone/ND 120 so that relevant marketing data may be outputted onto the display component 122. The smart phone/ND may contain an onboard storage capability in form of internal RAM. One skilled in the art may appreciate that the smart phone/ND 120 may additionally contain an image recording device such as a photo or video camera. The photo camera may, for instance, store images internally or sent them remotely to a location selected the by user or as directed by the PCC.

The ad server may utilize the connectivity interface 135 to control the smart phone/ND 120. For example, the ad server may be capable of upgrading or installing software running on the smart phone/ND 120 or of uploading navigational or entertainment data. The ad server may be capable of disabling the smart phone/ND 120, if for example, the user blocks or interferes with the stream of marketing data stored locally on the smart phone/ND 120 or downloaded regularly in FIG. 1 step 20. The subscription to the marketing data may not be capable of being turned off without forfeiting some or all of the refund for the smart phone/ND 120. The subscription may, however, be capable of being modified for a price, as a described at length herein.

In FIG. 3, the device 120 is shown displaying driving directions. However, the smart phone/ND 120 may be used in other settings as well. For example, the smart phone/ND may be used as a navigational device for other vehicles such as, but not limited to, a boat. The ad server may be capable of furnishing navigational information to such a device by uploading waterway, harbor and docking information. The marketing data in this embodiment may include services offered at closest marinas, beach side hotels, fuel stations, residences, and other tourist and boat servicing attractions. Other settings may be possible as well, such as, but not limited to a walking guide for urban areas or for hiking trails. In such embodiments the advertisers would be selected from merchants servicing pedestrian traffic or hikers, respectively. The user may be capable of setting the device ND 120 to a specific mode of travel, with the ad server adjusting the navigational, entertainment and marketing content accordingly.

FIG. 3 demonstrates one possible way in which the merchants furnish advertisement data to the PCC. The advertisement data may then become part of the marketing data sent to an ND 120. FIG. 3 step 21 utilizes tracking data generated in FIG. 3 steps 56 and 56A to determine the usage level of the marketing data sent to the smart phone/ND in step 20. The usage level may create additional charges or may justify charges applied to merchants in FIG. 3 step 22, with an invoice generated in FIG. 3 step 23. An automatic, periodic or any other billing structure common to the art may be used as well.

FIG. 3 demonstrates how the steps described in FIGS. 1 and 2 relate to the device 120. The user of the device 120 may be prompted to consent to the flow of marketing data in step 45. If the user declines in FIG. 3 step 41, the smart phone/ND may be disabled until a user pays for it in full, or it may function as any other navigational device, with the user not receiving any credit for the purchase of the device in FIG. 3 step 40.

If consent is obtained, the user may receive a steady stream of marketing data in step 30 that may be outputted to the user device in FIG. 3 step 50. The user may be able to forward the promotional information to another ND user in Fi 3 step 33. This action may be viewed as a referral 82 (FIGS. 1 and 2). A fully functional web-based interface may be provided to the user so that they can view, change settings or transfer points scored etc. The user may also have the capability to view or delete coupons, change preferences etc. using a browser of their choice.

Either the ad server or the smart phone/ND 120 may be capable of sorting and managing the marketing data stored locally or downloaded from the ad server or served dynamically. For example, in FIG. 3 step 36, the coupons and advertisements may be evaluated to determine their currency. In FIG. 3 step 35, the delays between displaying various advertisements may be adjusted manually or automatically. For example, in heavy traffic, the variation of ad content is preferably less rapid; but each individual ad may remain on the screen for longer. Also, in a region with few roads or with multiple geographic obstacles, the smart phone/ND 120 or the ad server may be able to determine that a particular merchant is actually out of range despite being physically near the device 120. In FIG. 3 step 37, the smart phone/ND 120 may have a choice between deleting outdated coupons, renewing them or replacing them with current versions.

If a user takes a requested action in FIG. 3 step 55, he or she may score points that are recorded in FIG. 3 step 56. If a user attempts to take an action but does not complete it, a credit may nonetheless be given, by calculating the miles driven toward the advertized location in step 56A. Other reward types may be used as well.

The user's usage of market data may be poled in FIG. 3 step 32 at predetermined intervals. If a sufficient level is reached, the user may be notified in FIG. 3 step 58, with a pre-agreed upon reward delivered to the user in FIG. 3 step 59B. Such a reward may be a dollar amount for using the marketing data, a dollar amount constituting a refund for the cost of the smart phone/ND 120 or another form of reward, such a better model of ND 120 FIG. 3 step 96.

If the user decides to mute the device he/she may receive a message in step 56B that they are not scoring any ad points.

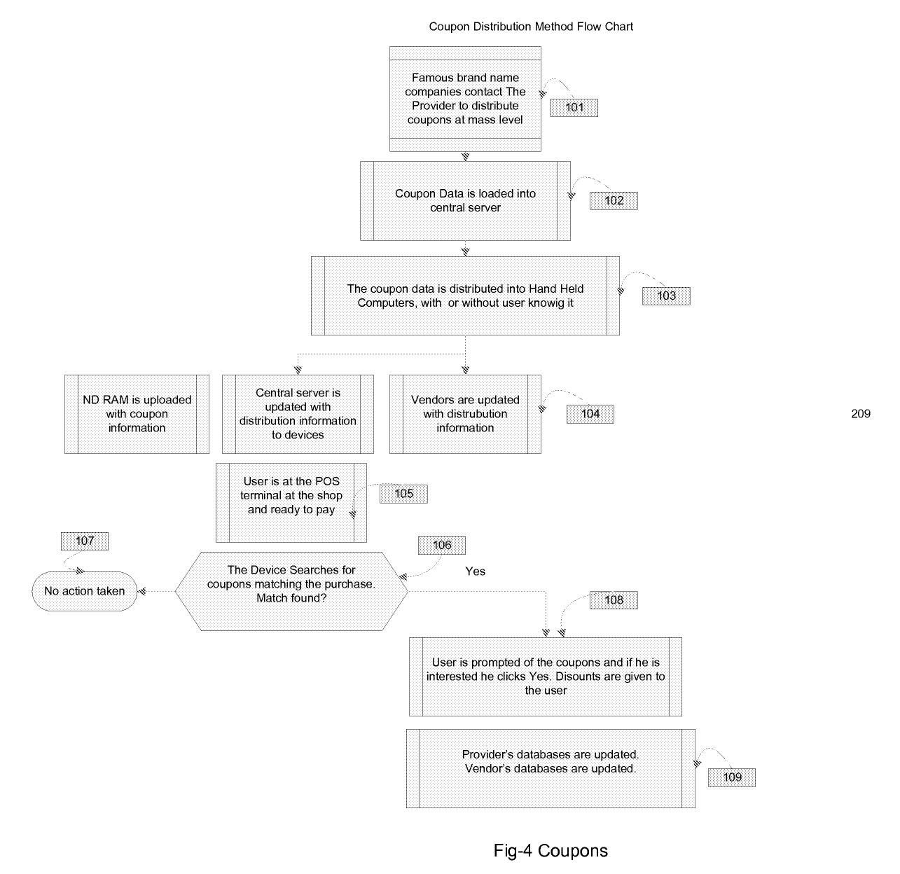

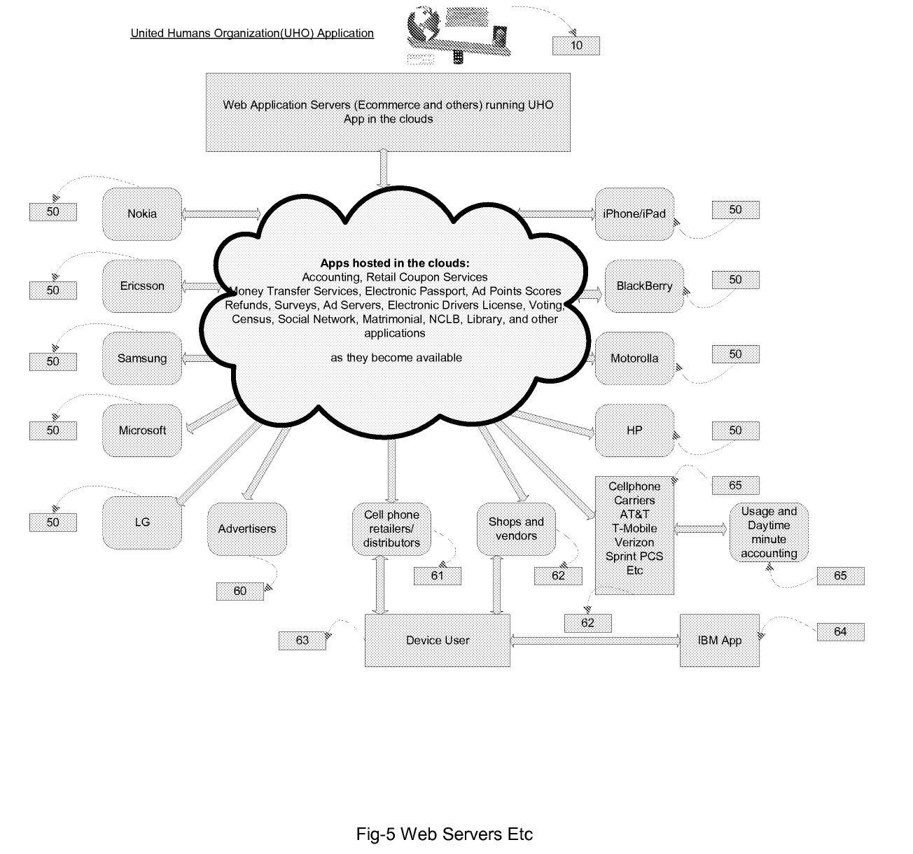

FIG. 4 illustrates the flow chart model of coupon distribution. In FIG. 4 step 101 famous brands may contact TTC to distribute their promotional coupons to the huge base of users available over the UH network. The data may be loaded into the ad server's coupon database, which may be distributed to the smart phone/ND 120s in FIG. 4 step 103.

Three things may be done in step 103.

1. An ND's memory may be loaded with coupons that become accessible to the user, and timely reminders can now be sent about their presence to the user.

2. A Central Server may keep track of the coupon distribution.

3. Vendors may then be updated to inform them that their coupons are already in the devices and not just sitting in mailboxes, waiting to be distributed.

When a user enters a shop or passes nearby, the smart phone/ND may know of potentially relevant coupons in FIG. 4 step 105 and may check for relevance of those coupons to the vendor/s in the immediate vicinity of the smart phone/ND in step 106. If no matches are found, no action may be taken in FIG. 4 step 107. If matches are found then the user may be prompted in FIG. 4 step 108 and if the user uses coupons then the appropriate discounts may be applied. The PCC databases may be updated and billing may now be undertaken, point tables updated and billing to vendors may also now be performed.

### Points Criteria Scoring:

A user may score points (or equivalent money in local currency in the country of operation)

The Points Scoring System and compensation to the user may work with the TG that may qualify The User for the agreed refund. The refund frequency and mode may be implicitly agreed upon upfront with The User. The refund may first and foremost be towards the bills of Internet, ND, ND Accessories, relevant product insurances and any other services that user may have acquired using the available credits. Other possible point systems may also be developed as the need arises. The points scoring criteria for each activity will be discussed separately.

Additional Incentives and applications will now be discussed. Each application may be designed so that The User may score points for performing activities that were only enabled for him due to the fact that he or she now owns The Device (ND) and relevant software and has access to the appropriate communication services provided by, for instance, the UH.

### DESCRIPTION OF OTHER PREFERRED EMBODIMENTS

The preferred embodiments of the present invention will now be described with reference to the drawings. Identical elements in the various figures are identified with the same reference numerals.

Such embodiments are provided by way of explanation of the present invention, which is not intended to be limited thereto. In fact, those of ordinary skill in the art may appreciate upon reading the present specification and viewing the present drawings that various modifications and variations can be made thereto.

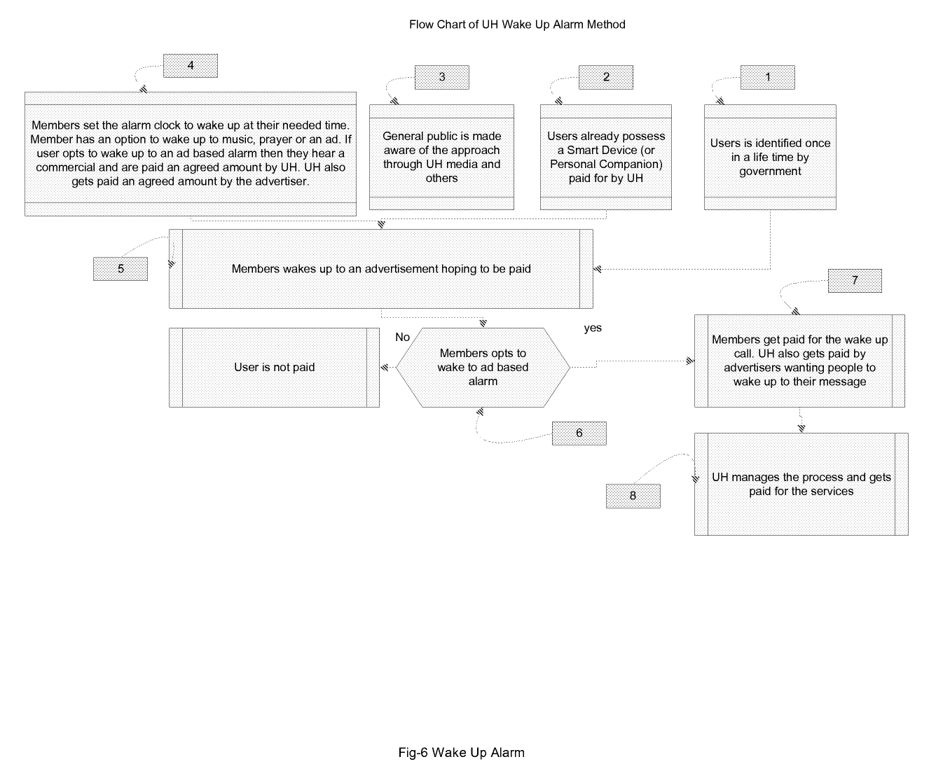

FIG. 6 illustrates some of the steps in a Flow Chart outlining processes in a UH Wake Up Alarm smart-phone application. The flow chart and the associated explanation of the flow chart, illustrate exemplary ways in which a user may receive compensation for the use of a UH smart-phone/ND application.

A smart phone FIG. 1, 120 having a GPS module 120 and a camera operating module 130 such as, but not limited to, a Personal companion or an automated Navigation Device (ND), may initially be linked to a government identity management server in order to establish the identity of a user of the smart phone 110.

In step 6.1, the user may, for instance, be identified by a relevant government agency when accessing the UH system for the first time. Identification may, for instance, be accomplished using available IDs such as, but not limited to, government or state issued drivers licenses, passports and other documentation, or by other suitable documentation such as credit cards, bank account statements, company identity cards. To help prevent fraud, the identification may, for instance, rely on the cumulative evidence of a number of documents, rather than on any single document. Once a user's identity has been verified, the relevant facts and documents related to that identification may be stored in a suitably secure location such as, but not limited to, a UH Cloud Based Server. Such a server may, for instance, may be utilized by the UH organization as well as by governments, suitable NGO's or other suitable organizations. The documents stored on the server may, for instance, include appropriate biometric identification data such as, but not limited to, photographs, finger prints, voice samples and DNA analysis.

In step 6.2, a user who does not already possess a suitable smart phone/ND may obtain one free of change from a UH source such as, but not limited to, a UH representative or website. In order to obtain the free smart phone, a user may be required to demonstrate eligibility for, and agree to participate at their convenience in, one or more suitable reimbursable mode options 170. These reimbursable mode options may, for instance, include options such as, but not limited to, a charity mode option, an advertising mode option and a carbon micro-credit mode option. In the advertising mode option the user may, for instance, agree to allow uninterrupted flow of commercial Ads to themselves.

In step 6.3, a user who may be unaware of the existence of the free smart phones 110 provided by the UH, may be informed of the potential benefits to them of by various media channels such as, but not limited to, UH advertising, infomercials and other information dissemination methods.

In step 6.4 a user may set their smart phone or ND to operate a UH alarm clock application to wake up them at a predetermined time. Users may, for instance, have an option to wake up to their choice of music, a prayer or an advertisement or a combination thereof. If users opt to wake up to an ad based alarm then they may hear a commercial for a wake up call and may be paid, or credited an agreed monetary amount by the UH organization. The UH organization may also be paid by the advertiser. In order to maintain the organization, the amount received by the UH organization is preferably more is the UH organization may be obligated to pay to the user.

In Step 5 a user may wake up to an advertisement with the expectation of being paid for listening to the advertisement.

In Step 6.6, a user's settings may be checked in order to ensure that they opted to wake up to an advertisement. Based on the detected settings of the user's smart phone/ND, a decision a decision may be made by the UH organization, or their agents, to pay the user.

In Step 6.7, a user may be paid for having selected an advertisement to be played as a part of their wakeup call. The UH organization may also get paid by advertisers wanting people to wake up to their message. The money paid by the advertiser may be used, in part or in full, to pay for the provision of free, or heavily subsidized, smart phones, and/or free or heavily subsidized service provision for the use of the smart phones.

In Step 6.8, the UH organization may manage the process of providing services such as, but not limited to, providing free smart phones and providing compensation for the use of smart-phone applications. The UH organization may be compensated for providing such services.

### Further Innovative Applications Will Now Be Described in Detail.

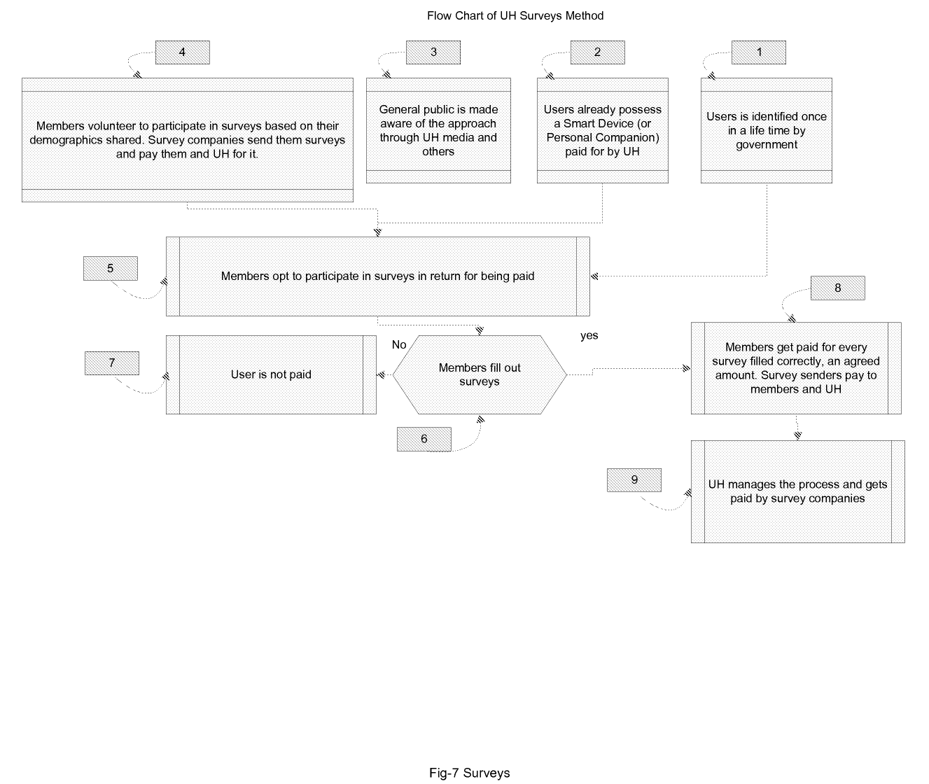

### FIG. 7 Illustrates Flow Chart Outlining UH Surveys Method:

Steps 7.1, 7.2 and 7.3 are analogous to the correspondingly numbered steps described in reference to FIG. 6 above.

In Step 7.4, members may volunteer to participate in surveys based on the demographics they may have shared when initially agreeing to participate in the UH organization's program to receive compensation for using smart-phone application.

Survey companies may send the users surveys and compensate them and the UH organization for the user's participation in the surveys. The amount paid to members and to the UH organization may, for instance, be determined using market forces such as, but not limited to, competitive auctions. Survey companies may be provided the demographic information of participants but in a preferred embodiment may NOT be provided with personal details without the explicit consent of the member.

In Step 7.5, members may consent to participate in one or more surveys that may be furnished to them through the UH organization. The participants may, for instance, be selected to receive a particular survey based on the demographic information they previously provided to the UH. In this way, the surveys may be made relevant to the user based on, for instance, factors such as, but not limited to their qualifications and buying behavior etc. This relevancy may make the survey results more attractive, and therefore potentially of more value, to the companies requesting they be performed.

In Step 7.6, a member may decline to participate in any particular survey. In a preferred embodiment, opting out of a survey may mean not participating in any UH revenue generated by that survey.
In Step 7.7, the member may fill out a survey.
In Step 7.8, the accuracy and completeness of the completed surveys may be verified by, for instance, an automated program running on the UH server. The user may then be informed of the amount of compensation that has or will be credited to their account.
In Step 7.9 the UH organization may bill the relevant surveying company and, in a preferred embodiment, may be paid as agreed

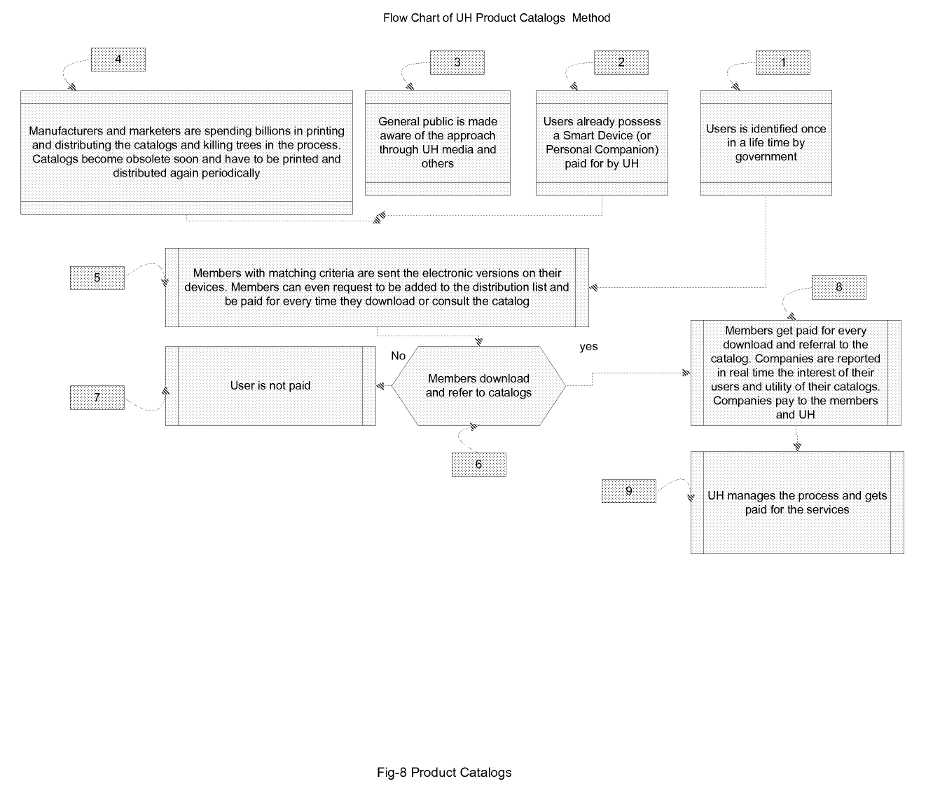

### FIG. 8 Illustrates a Flow Chart Outlining UH Product Catalogs Method.

This application is intended to help eliminate the huge and costly waste of paper and energy associated with producing and distributing catalogs such as, but not limited to parts catalogs, product catalogs, and reference catalogs Etc. The savings realized by eliminating the printed catalogs and instead providing them via the smart phones distributed by the UH organization, may be directed towards coving the cost of providing the smart phones and paying the service charges associated with using the smart phones.

Steps 8.1, 8.2 and 8.3 are analogous to the correspondingly numbered steps described in reference to FIG. 6 above.
In Step 8.4, a user may be informed of how manufacturers and marketers may be spending billions in printing and distributing catalogs, typically wasting energy and unnecessarily destroying trees and other limited recourses in the process. The user may also be made aware of other shortcomings of paper catalogs such as, but not limited to, how they become rapidly obsolete, necessitating frequent re-printing and re-distribution. Typically changes to a printed catalogue take about six months to reach the end user, whereas alterations to on-line catalogues that may be available via the UH distributed free smart phones or web based soaftware, allows for real time updating of the catalogue.
In Step 8.5, members matching appropriate criteria may be sent offers to download electronic catalogues, or the necessary information to allow them to access the electronic versions using their smart phone devices. A log may be kept of who downloaded the catalog and how much money was paid towards the free device also called ND. Members may, for instance, request to be added to the distribution list of particular catalogues, and may be compensated each time they download a catalogue or a portion of a catalogue. Members may also be paid a small amount each time they consult the electronic catalog. In addition to providing the information required by the user, the payment for obtaining that information may give them an additional incentive to return to that particular catalogue. Such an incentive may be an effective way for the catalogue provider to build brand loyalty.
In Step 8.6, the member may decide if they want to be paid. If they opt to be paid then they may download one or more of the catalogs on offer from participating manufacturers and other agencies.
In Step 8.7 the member is not paid as they are not interested in participating
In Step 8.8, Members may get paid for every download and referral to the catalog. Companies may receive real time reports detailing the users interests other metrics that may provide insights regarding factors such as, but not limited to, the utility of their catalogs. Companies may pay the members for accessing their catalogues, and the UH organization for providing the electronic distribution platform. The payments may be according to a schedule that may be negotiated and agreed to prior to the electronic distribution of the catalogues.
In Step 8.9, the UH organization may manage the entire process and may receive additonal compensation for providing such services.

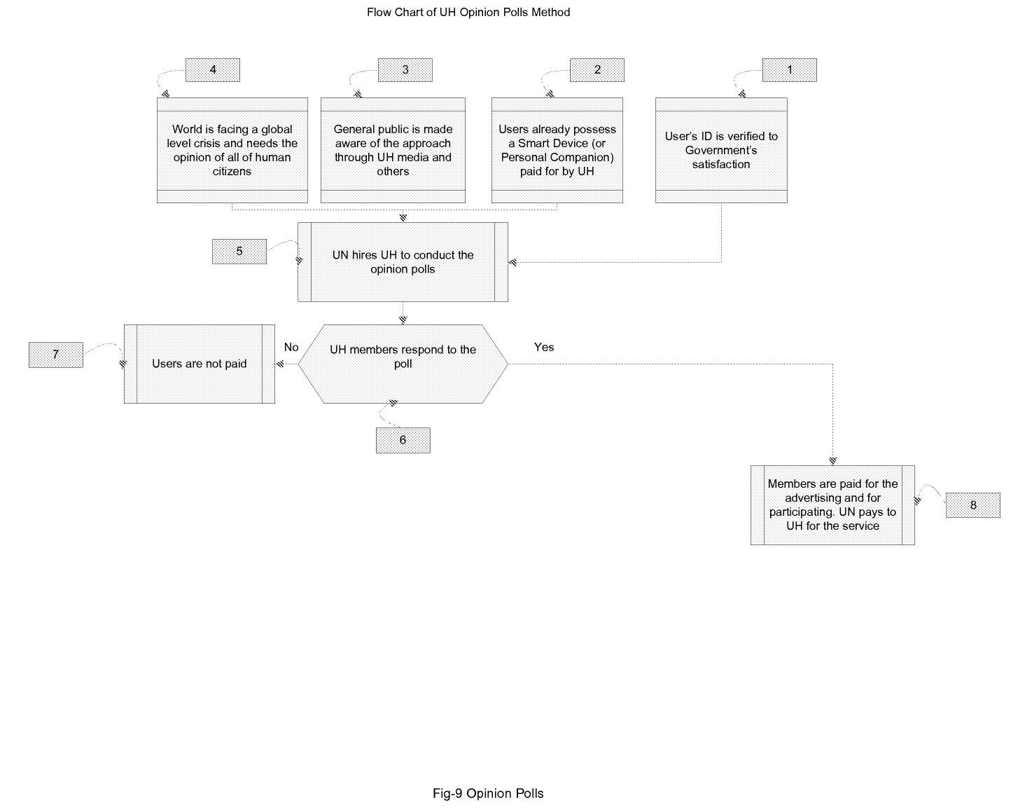

### FIG. 9 Illustrates Flow Chart Outlining UH Opinion Polls Method:

Steps 9.1, 9.2 and 9.3 are analogous to the correspondingly numbered steps described in reference to FIG. 6 above.

In Step 9.4, inventors see a huge utility of a free ND as envisioned in this patent application. General public can be called in to poll for matters of urgency facing all human citizens or any geograpgy or political senario. It can be used to get help in disasters etc.

In Step 9.5, an entity like United Nations may hire UH to conduct the opinion polls across all countries in real time.
In Step 9.6, UH members may decide to respond to the polls or not.
In Step 9.7, Users may be ignored for not opting to participate
In Step 9.8, Members may be paid for the advertising and for participating. UN or the requesting entity may pay the UH for the service. Members may get paid for participating in the polls.

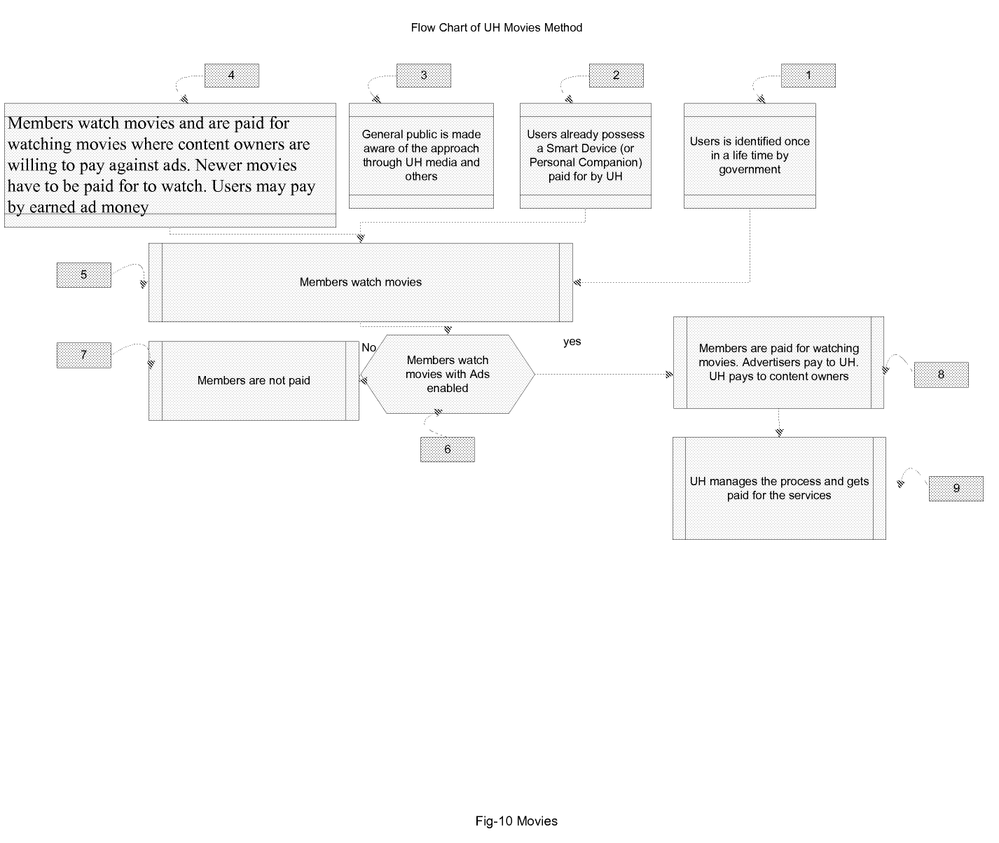

### FIG. 10 Illustrates Flow Chart Outlining UH Movies Method:

Steps 10.1, 10.2 and 10.3 are analogous to the correspondingly numbered steps described in reference to FIG. 6 above.

In Step 10.4 members may watch movies and may be paid (it may be a very small sum of money) for watching the movies. The content owners may, for instance, be willing to pay for the ads served during the movie's playtime. Newer movies may have to be paid for to watch. Users may pay by earned ad money. This may enable them to watch a new movie when they are in a mood for it and watch ads when they have time and inclination for watching ads. This makes them more attractive audience for advertisers and this approach to manage surveys may become a huge hit with movie lovers. The same approach may be used for other video content like oplitical a speeched etc.
In Step 10.5 the members may watch movies without annoying interruptions from marketers.
In Step 10.6 they have the option to include ads if they want to be paid
In Step 10.7 they are not paid if they do not want ads, they will have to pay for movies if they opted out of ads
In Step 10.8 members are paid for watching movies as stated. Advertisers pay to UH, UH then pays to content owners
In Step 10.9 UH manages the process and gets paid for the services of managing the web site etc.

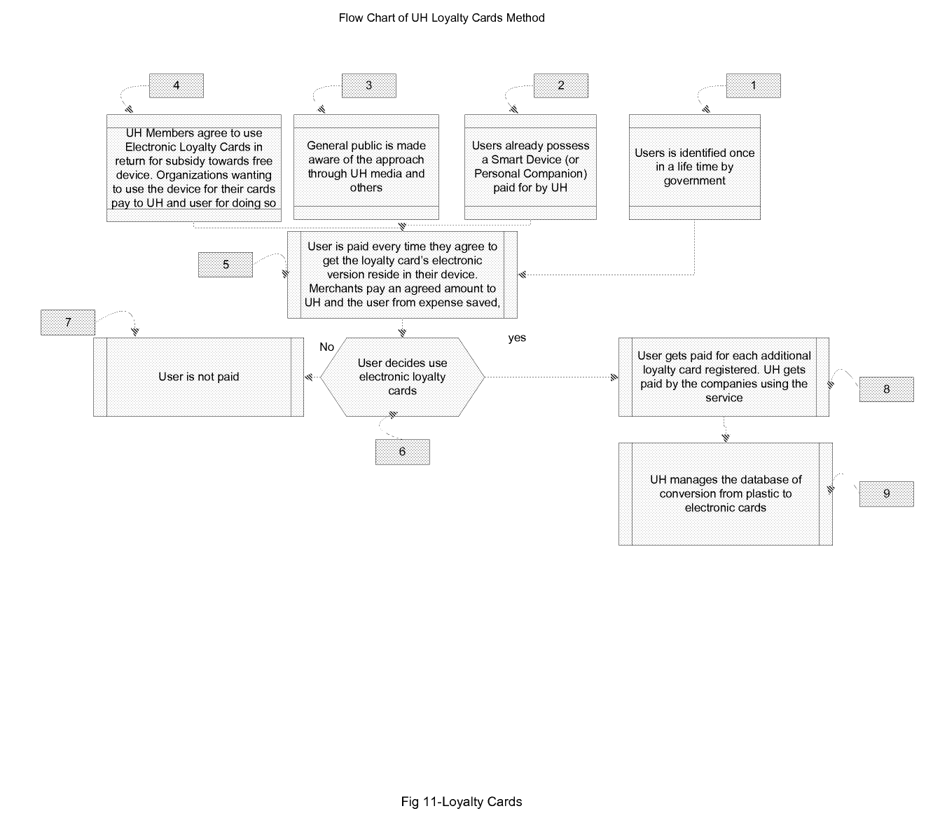

### FIG. 11 Illustrates Flow Chart Outlining Loyalty Cards Method

Steps 11.1, 11.2 and 11.3 are analogous to the correspondingly numbered steps described in reference to FIG. 6 above.
In Step 11.4 UH, Members may agree to use Electronic Loyalty Cards in return for subsidy towards the free device that they have been provided earlier. Organizations wanting to use the device for their cards may pay (and save the cost of plastic and other overheads) an agreed amount to UH for facilitating and to the user for agreeing to do so.
In Step 11.5, a user may be paid every time they agree to get the loyalty card's electronic version reside in their device. Merchants pay an agreed amount to UH and the user from expense saved.
In Step 11.6 user may decide use electronic loyalty cards
In Step 11.7 users may not be paid if they decline to use the feature
In Step 11.8 user may get paid for each additional loyalty card registered. UH may get paid by the companies using the service
In Step 11.9 UH may manage the database of conversion from plastic to electronic cards. Major stores such as, but not limited to, Shoprite or Pathmark, may use the service to save money and add ease of use to their customers. This activity may subsidize the devices provided

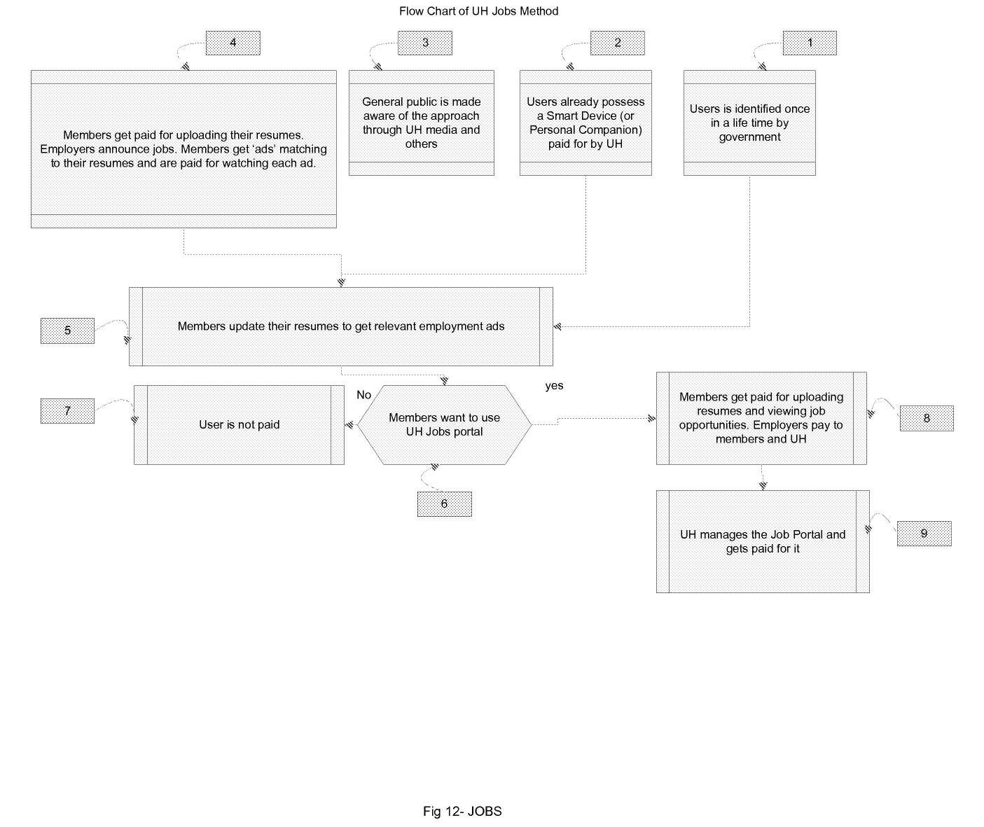

### FIG. 12 Illustrates Flow Chart of UH Job Portal Method

Steps 12.1, 12.2 and 12.3 are analogous to the correspondingly numbered steps described in reference to FIG. 6 above.
In Step 12.4, members may get paid an agreed amount for uploading their resumes. When employers announce jobs, members may get ‘ads’ matching their resumes and may be paid for watching each of the Ads.
In Step 12.5, members may update their resumes and relevant employment ads may be filtered by the employee and employer criteria and where a match is found, the ads may be served to qualified candidates. Members may be shown an amount payable to them for clicking on employment opportunities.
In Step 12.6, members may decide not to participate
In Step 12.7 members may not be paid for opting out of this feature, as they may be currently employed.
In Step 12.8 members may get paid for uploading resumes and viewing job opportunities. Employers may pay the members and the UH
In Step 12.9 UH may manage the Job Portal and may get paid for it

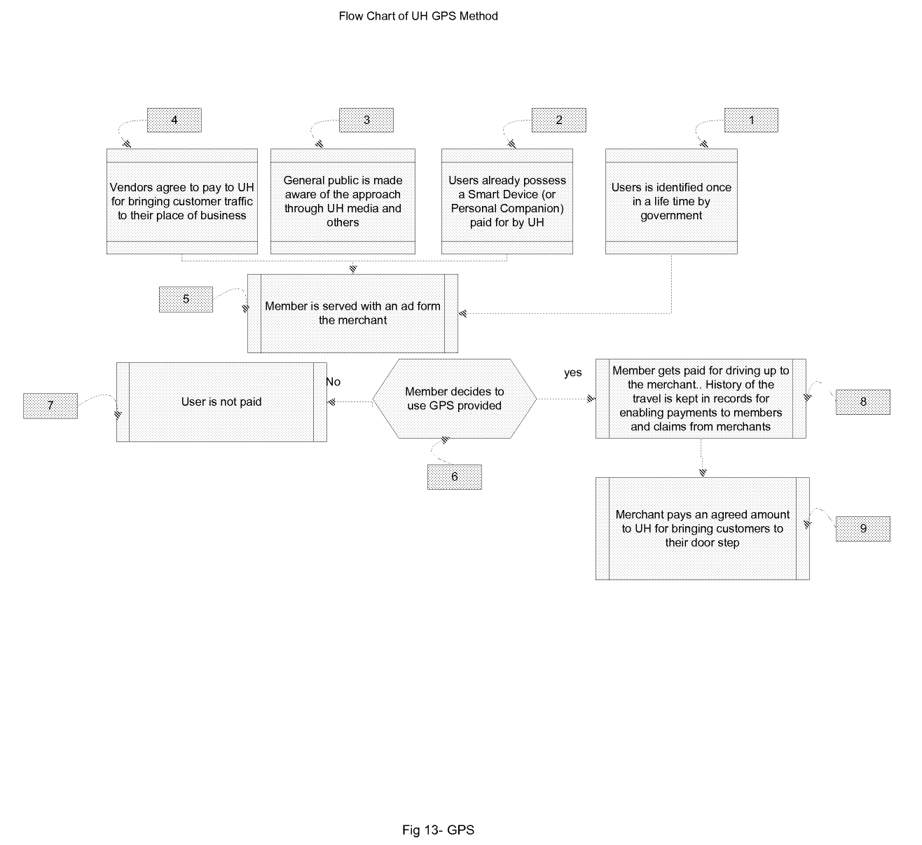

### FIG. 13 Illustrates Flow Chart of UH GPS Method

Steps 13.1, 13.2 and 13.3 are analogous to the correspondingly numbered steps described in reference to FIG. 6 above.
In Step 13.4, vendors and businesses may agree to pay to UH for bringing customer traffic to their place of business
In Step 13.5, members may be served with an ad form the merchant, who is interested in inviting them to their place of business. This may also happen from any other way an Ad is served to members
In Step 13.6 member may decides if they want to use the feature or not
In Step 13.7 members may not be paid if they opt out
In Step 13.8 member may gets paid for driving up to the merchant. History of the travel may be kept in records for enabling payments to members and claims from merchants
In Step 23.9 The Merchant may pay an agreed amount to UH for bringing customers to their door step

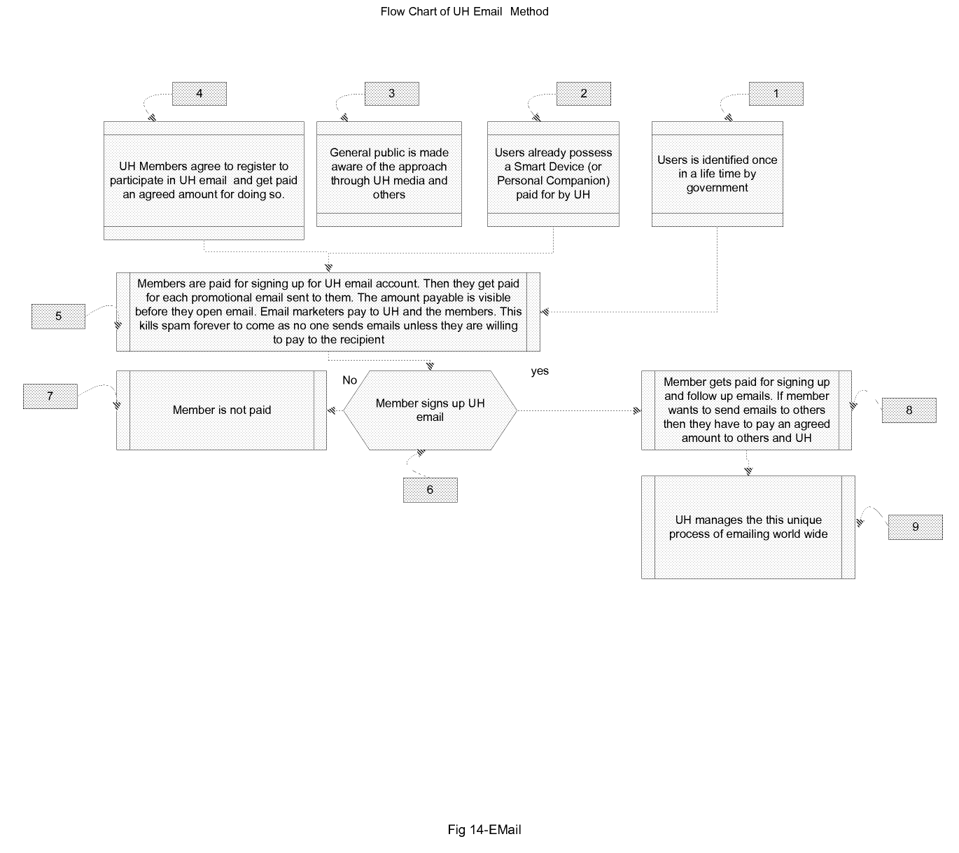

### FIG. 14 Illustrates Flow Chart of UH Email Method

Steps 14.1, 14.2 and 14.3 are analogous to the correspondingly numbered steps described in reference to FIG. 6 above.
In Step 14.4 members may agree to register to participate in UH email and get paid an agreed amount for doing so.
In Step 14.5 Members may be paid for signing up for UH email account. Then they may get paid for each promotional email sent to them. The amount payable may be visible before they open email. Email marketers may pay the UH and the members. This may kill spam forever as no one sends emails unless they are willing to pay to the recipient
In Step 14.6 members may decide to signup for this feature
In Step 14.7 members may not be paid for opting out
In Step 14.8 member gets paid for signing up and follow up emails. If a member wants to send promotional emails to others then they may have to pay an agreed amount to others and UH
In Step 14.9 The UH may manage this unique process of emailing worldwide and may be paid for it

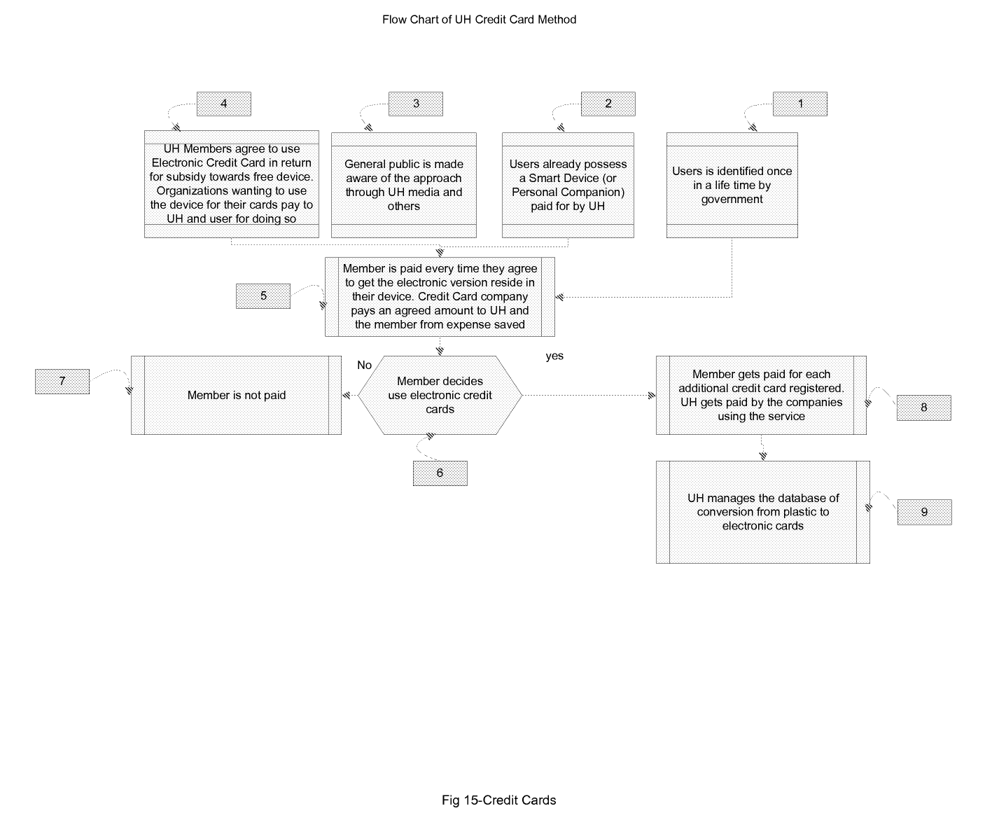

### FIG. 15 Illustrates Flow Chart of UH Credit Card Method

Steps 15.1, 15.2 and 15.3 are analogous to the correspondingly numbered steps described in reference to FIG. 6 above.
In Step 15.4 UH members may agree to use Electronic Credit Card in return for subsidy towards free device. Organizations wanting to use the device for their cards may pay the UH and members for doing so
In Step 15.5 member may be paid every time they agree to get the electronic version reside in their device. The Credit Card Company may pay an agreed amount to UH and the member from expense saved
In Step 15.6 a member may decide to signup for this feature
In Step 15.7 members may not be paid for opting out
In Step 15.8 member may get paid for each additional credit card registered. The UH may get paid by the companies using the service
In Step 15.9 UH may manage the database of conversion from plastic to electronic cards and may get paid in the process. The UH may decide to offer their own Credit Cards, subject to governement approvals.

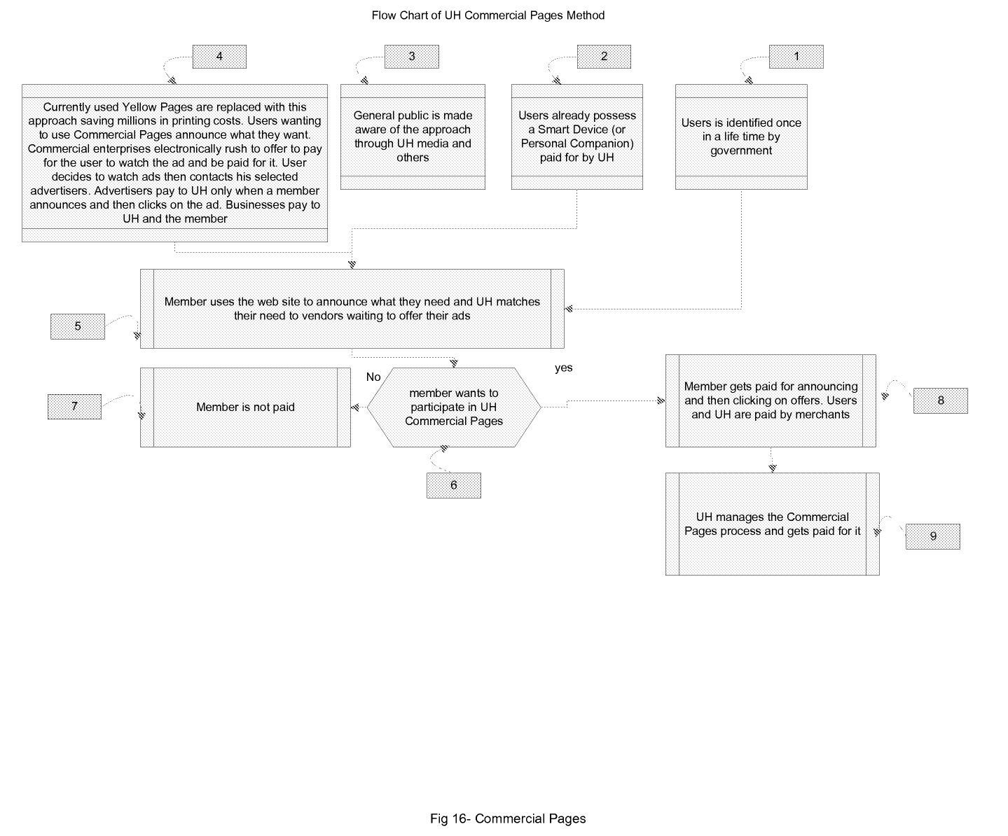

### FIG. 16 Illustrates Flow Chart of UH Email Method

Steps 16.1, 16.2 and 16.3 are analogous to the correspondingly numbered steps described in reference to FIG. 6 above
In Step 16.4 currently used Yellow Pages and other electronic equivalents are replaced with this approach saving millions in printing costs. Users wanting to use Commercial Pages announce what they want to buy or to check out before buying. Commercial enterprises electronically rush to offer to pay for the user to watch the ad and be paid for it. User decides to watch ads then contacts his selected advertisers. Advertisers may pay to UH only when a member announces and then clicks on the Ad. Businesses pay to UH and the member
In Step 16.5 a member may use the web site to announce what they need and the UH may match their need to vendors waiting to offer their ads
In Step 16.6 a member may decide to participate in UH Commercial Pages
In Step 16.7 a member may not be paid for opting out
In Step 16.8 member may gets paid for announcing and then clicking on offers. Users and UH may be paid by merchants
In Step 16.9 UH may manage the Commercial Pages process and may gets paid for it

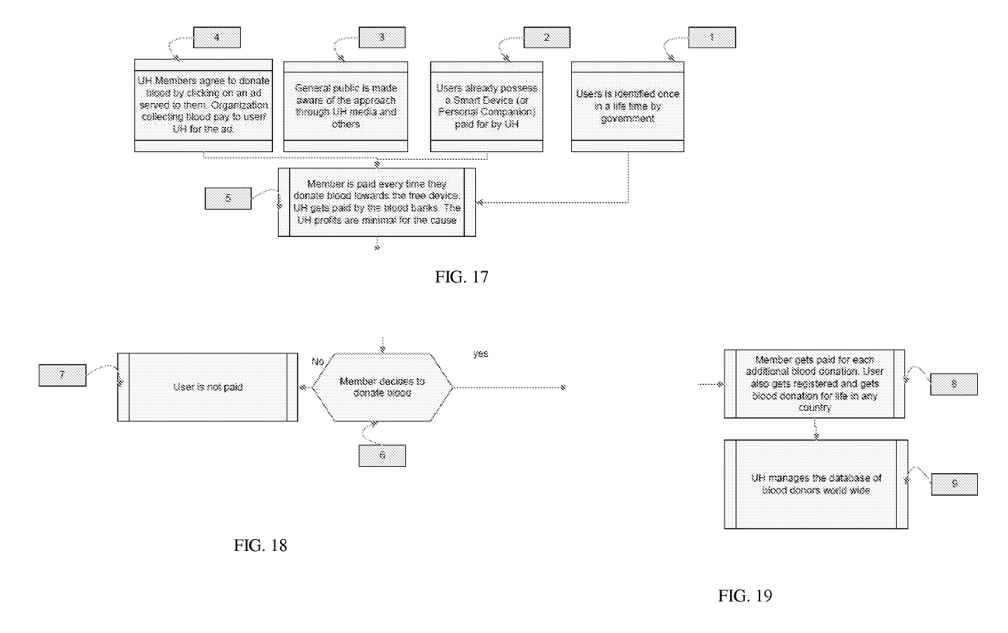

### FIG. 17 Illustrates Flow Chart of Blood Donation Method

Steps 17.1, 17.2 and 17.3 are analogous to the correspondingly numbered steps described in reference to FIG. 6 above
In Step 17.4 members may agree to donate blood by clicking on an ad served to them. Organization collecting blood pay to member/UH for the Ad.
In Step 17.5 member may be paid every time they donate blood towards the free device. UH gets paid by the blood banks. The UH profits are minimal for the cause
In Step 17.6 member may decides to donate blood
In Step 17.7 member may not be paid for opting out
In Step 17.8 member may get paid for each additional blood donation. User also gets registered and gets blood donation for life in any country
In Step 17.9 UH may manage the database of blood donors worldwide and every member who has donated blood once or agrees to donate blood when needed, may get blood transfusions free in any country he may be visiting

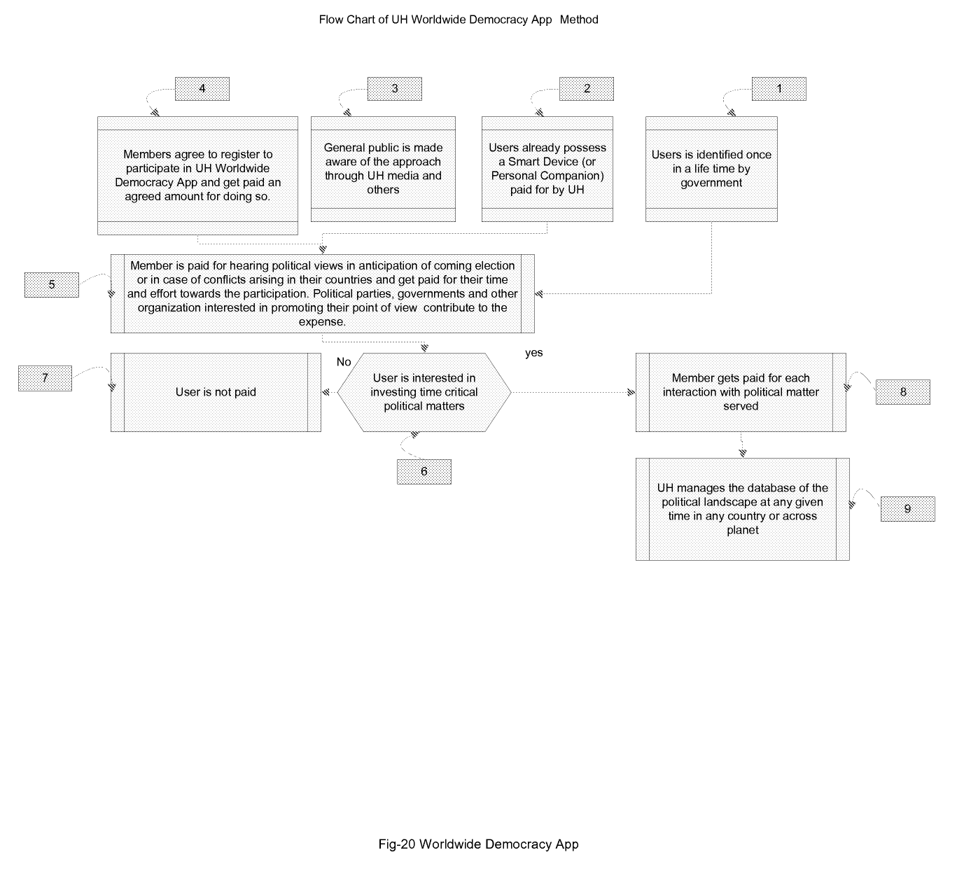

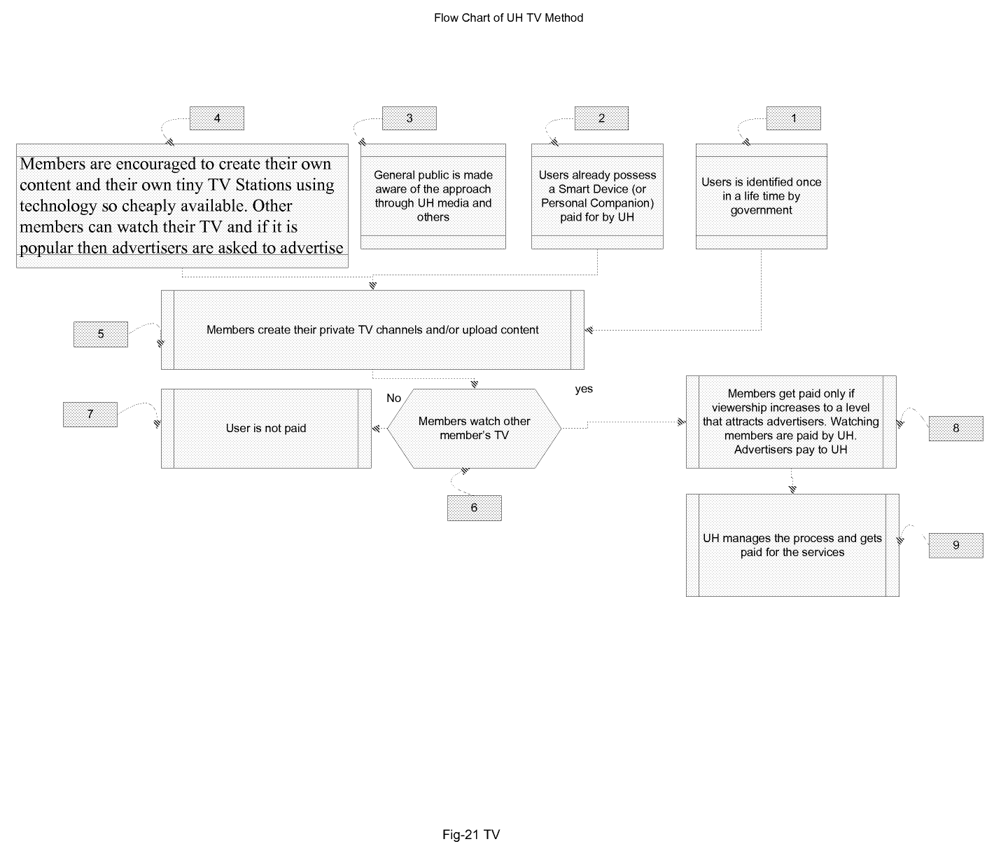

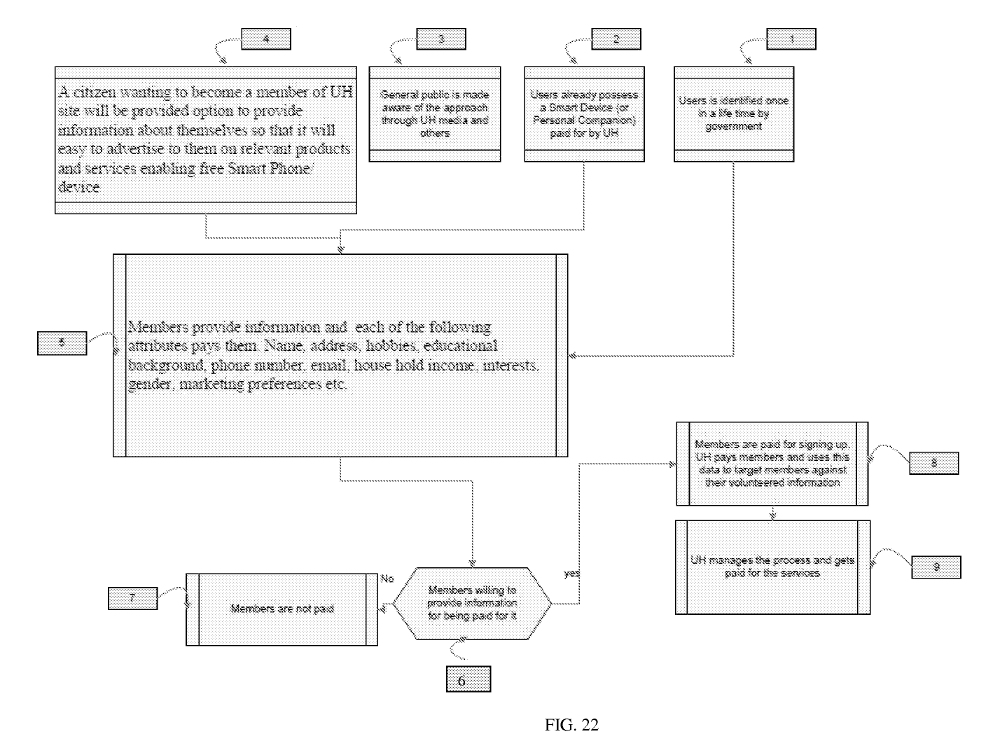

### FIG. 20 Illustrates Flow Chart of World Wide Democracy App Method

Steps 20.1, 20.2 and 20.3 are analogous to the correspondingly numbered steps described in reference to FIG. 6 above
In Step 20.4 members may agree to register to participate in UH Worldwide Democracy App and may get paid an agreed amount for doing so.
In Step 20.5 a member may be paid for hearing political views in anticipation of an upcoming election or of conflicts arising in their countries and may get paid for the time and effort of their participation. Political parties, governments and other organization interested in promoting their point of view may contribute to the expense.
In Step 20.6 member may decide to opt out
In Step 20.7 member may not be paid for opting out
In Step 20.8 member may get paid for each interaction with political material served
In Step 20.9 UH may manage the database of the political landscape at any given time in any country or across planet and may get paid for doing so.

### FIG. 21 Illustrates Flow Chart of UH TV App Method

Steps 21.1, 21.2 and 21.3 are analogous to the correspondingly numbered steps described in reference to FIG. 6 above
In Step 21.4 members are encouraged to create their own content and their own tiny TV Stations using technology so cheaply available. Other members can watch their TV and if it is popular then advertisers are asked to advertise
In Step 21.5 members create their private TV channels and/or upload content
In Step 21.6 members decide to participate or not to participate
In Step 21.7 members are not paid for opting out
In Step 21.8 members get paid only if viewership increases to a level that attracts advertisers. Watching members are paid by UH. Advertisers pay to UH
In Step 21.9 UH manages the process and gets paid for the services

### FIG. 22 Illustrates Flow Chart of UH Signup App Method

Steps 22.1, 22.2 and 22.3 are analogous to the correspondingly numbered steps described in reference to FIG. 6 above
In Step 22.4 any citizen wanting to become a member of UH site may be provided option to provide information about himself or herself so that it may be easy to advertise to them on relevant products and services enabling free Smart Phone/device. Members providing more information about their buying patterns will be rewarded more in the long run also as only relevant ads will reach them.
In Step 22.5 members provide information and each of the following attributes pays them. For example name, address, hobbies, educational background, phone number, email, house hold income, interests, gender, marketing preferences etc.
In Step 22.6 members may decide to opt out
In Step 22.7 members are not paid for opting out
In Step 22.8 members are paid for signing up. UH pays members and uses this data to target members against their volunteered information
In Step 22.9 UH manages the process and gets paid for the services

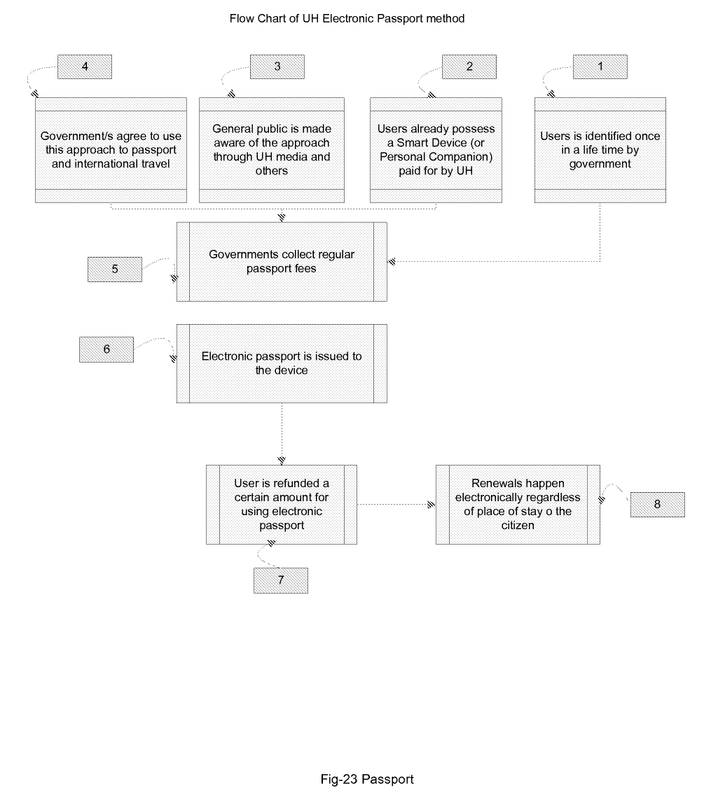

### FIG. 23 Illustrates Flow Chart of UH Electronic Passport App Method

Steps 23.1, 23.2 and 23.3 are analogous to the correspondingly numbered steps described in reference to FIG. 6 above
In Step 23.4 Government/s may agree to use this approach to electronic passport and international travel
In Step 23.5 governments may collect regular passport fees
In Step 23.6 Electronic Passport may be issued to the member and it may reside in the free device that may be provided
In Step 23.7 member may be refunded a certain amount for using electronic passport, which is used to subsidize the free device
In Step 23.8 renewals may happen electronically regardless of the place of stay of the citizen. Visas may now be issued electrically without the passport leaving the possession of the citizen. Governments may track movements of the person, if suspected or needed by a situation. UH may get paid fees for helping save money in physically moving passports and saving money to public

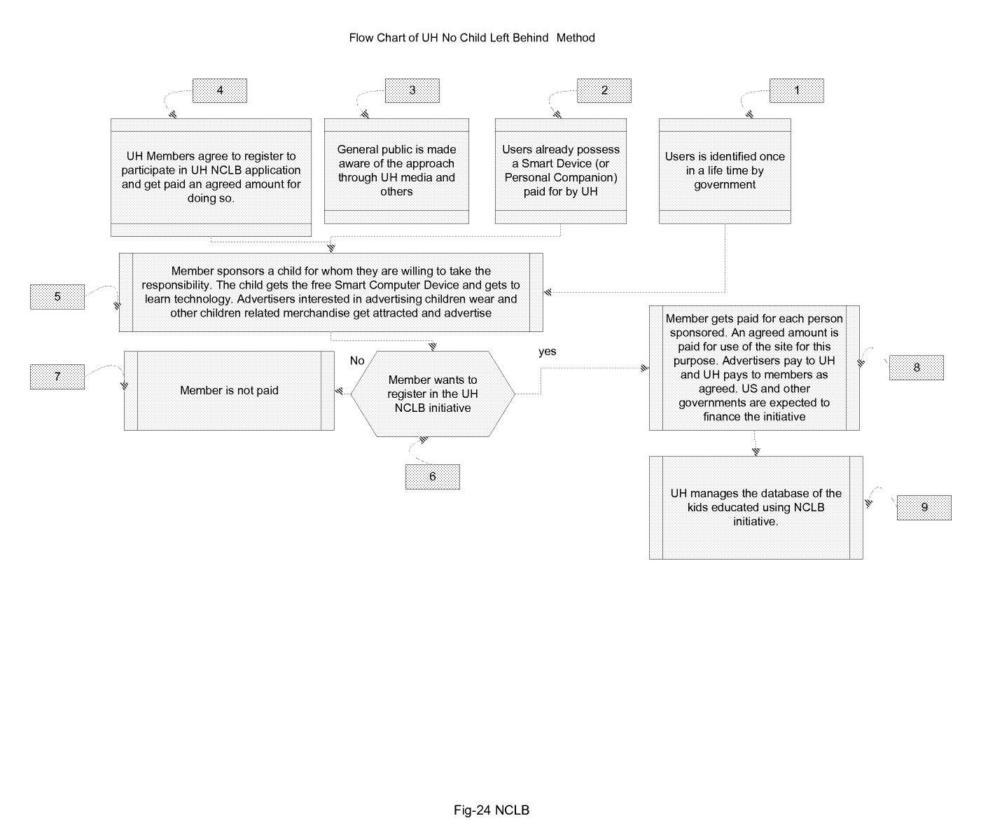

### FIG. 24 Illustrates Flow Chart of UH NCLB (No Child Left Behind) App Method

Steps 24.1, 24.2 and 24.3 are analogous to the correspondingly numbered steps described in reference to FIG. 6 above
In Step 24.4 members may agree to register to participate in UH NCLB application and may get paid an agreed amount for doing so.
In Step 24.5 member may sponsor a child for whom they are willing to take the responsibility. The child may get the free Smart Computer Device and may get to learn technology. Advertisers interested in advertising children wear and other children related merchandise may get attracted and may decide to advertise
In Step 24.6 members may decide if they want to participate
In Step 24.7 members may not be paid for opting out
In Step 24.8 member may be paid for each person sponsored. An agreed amount may be paid for use of the site for this purpose. Advertisers may pay to UH and UH may pay to members as may be agreed with them. US and other governments may be expected to finance the initiative, which will cost much less due to ad based subsidy
In Step 9 UH may manage the database of the children educated using NCLB initiative.

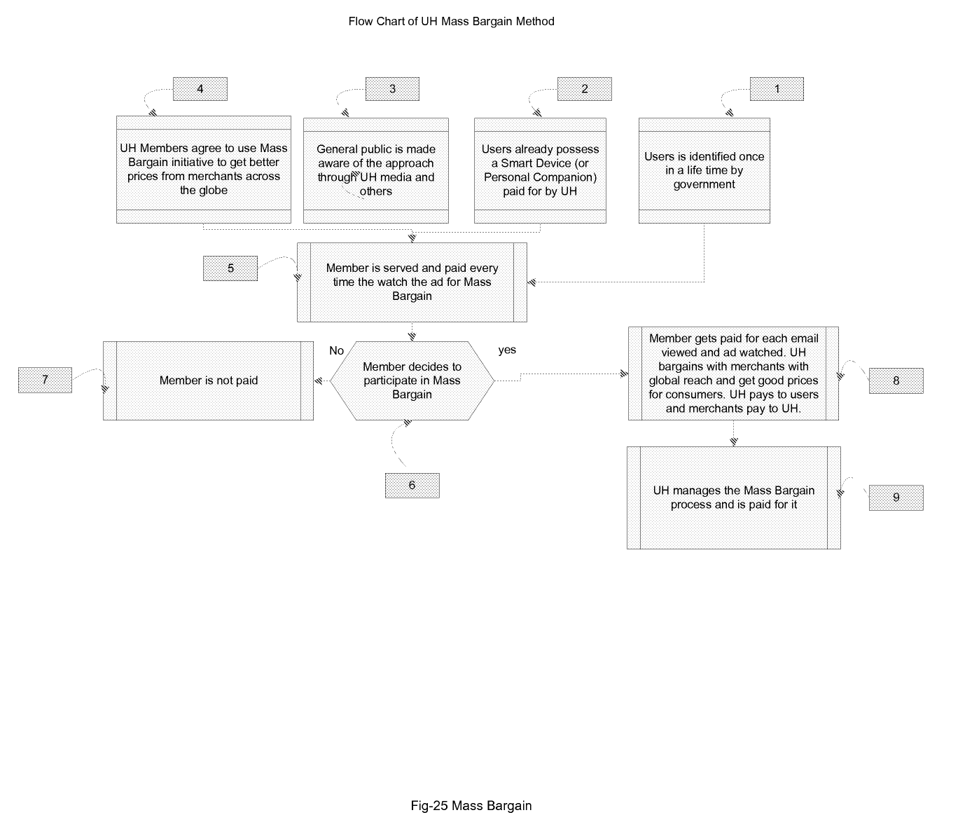

### FIG. 25 Illustrates Flow Chart of Mass Bargain App Method

Steps 25.1, 25.2 and 25.3 are analogous to the correspondingly numbered steps described in reference to FIG. 6 above
In Step 25.4 members may agree to use Mass Bargain initiative to get better prices from merchants across the globe
In Step 25.5 member may be served and may be paid every time the watch the ad for Mass Bargain
In Step 25.6 member may opt out of the feature
In Step 25.7 member may not be paid for opting out
In Step 25.8 member may get paid for each email viewed and ad watched. UH may bargain with merchants with global reach and may get good prices for consumers. UH may pay to users and merchants may pay to UH.
In Step 25.9 UH may manage the Mass Bargain process and may be paid for it

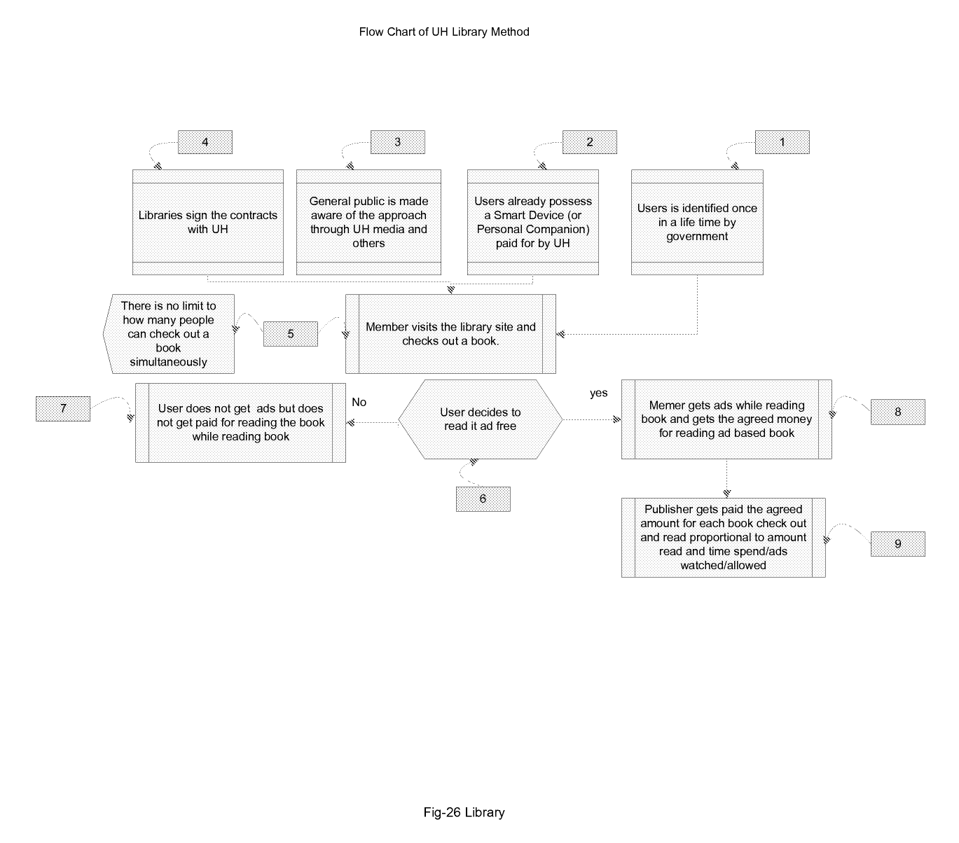

### FIG. 26 Illustrates Flow Chart of Libraries App Method

Steps 26.1, 26.2 and 26.3 are analogous to the correspondingly numbered steps described in reference to FIG. 6 above
In Step 26.4 libraries across the globe sign the contracts with UH
In Step 26.5 member may visit the library site and may check out a book. There may be no limit to how many people may check out a book simultaneously
In Step 26.6 member may decide to read the book ads free
In Step 26.7 member may not get ads but may not get paid for the time they are reading the book In Step 26.8 member may get ads while reading book and may get the agreed money for reading ad based book
In Step 26.9 publisher may get paid the agreed amount for each book checked out and read proportional to amount read and time spent/ads watched/allowed

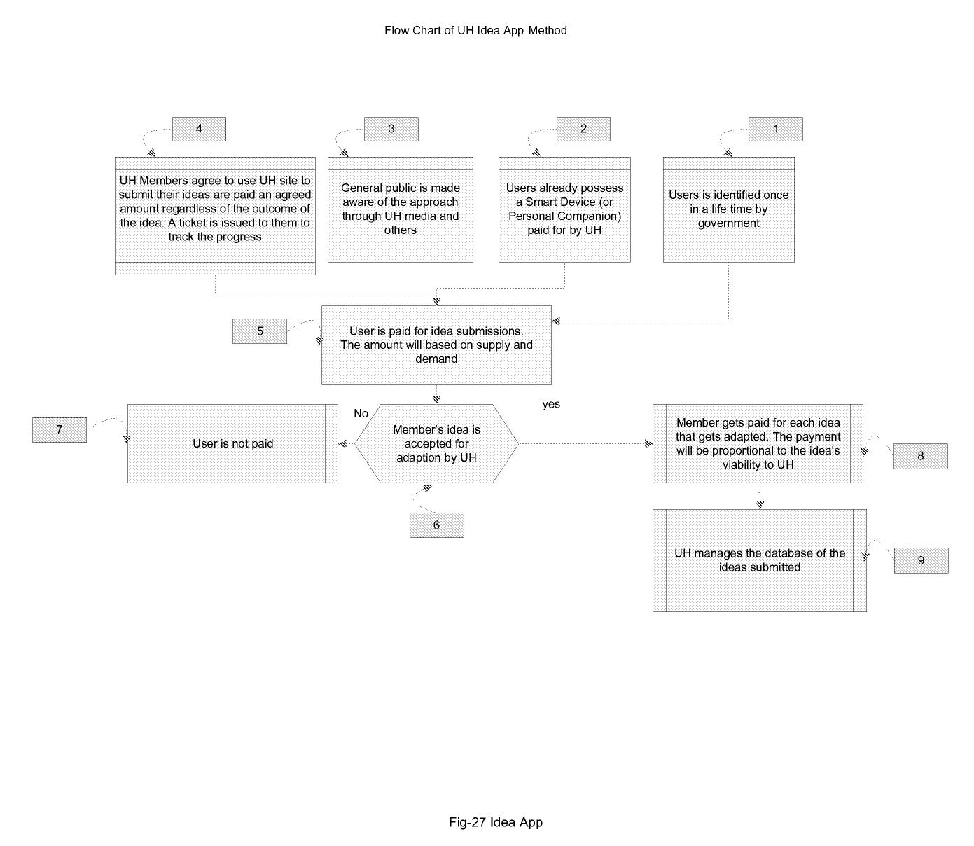

### FIG. 27 Illustrates Flow Chart of Ideas App Method

Steps 27.1, 27.2 and 27.3 are analogous to the correspondingly numbered steps described in reference to FIG. 6 above
In Step 27.4 members may agree to use UH site to submit their ideas and may be paid an agreed amount regardless of the outcome of the idea. A ticket may be issued to them to track the progress
In Step 27.5 member may be paid for idea submissions. The amount may be based on supply and demand
In Step 27.6 member's idea may be evaluated if it is to be accepted for adaption by UH or not
In Step 27.7 member may not be paid if the idea may be rejected
In Step 27.8 member may get paid for each idea that may get adapted. The payment may be proportional to the idea's viability to UH
In Step 27.9 UH may manage the database of the ideas submitted and may adapt great ideas submitted from all over the world while benefiting the contributors

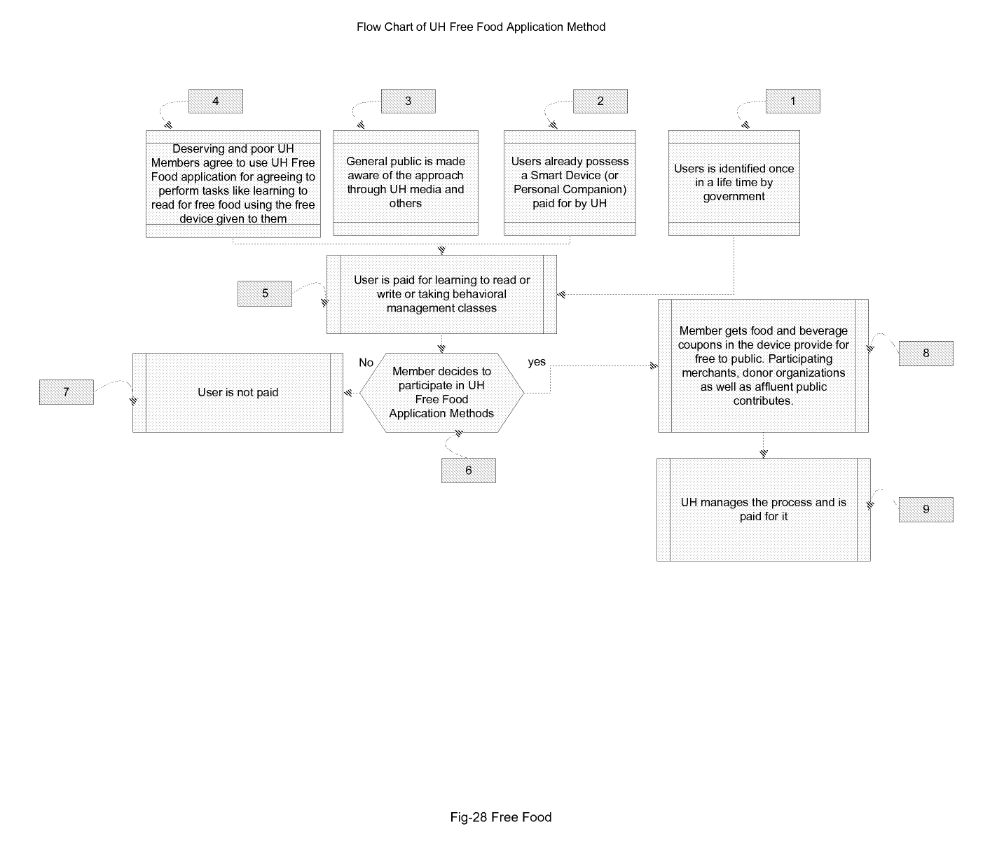

### FIG. 28 Illustrates Flow Chart of Free Food App Method

Steps 28.1, 28.2 and 28.3 are analogous to the correspondingly numbered steps described in reference to FIG. 6 above
In Step 28.4 deserving and poor UH members may agree to use UH Free Food application for agreeing to perform tasks like learning to read for free food and personal hygiene etc. using the free device given to them
In Step 28.5 member may be paid (or provided food) for learning to read or write or taking behavioral management classes
In Step 28.6 member may decide to opt out if they liked
In Step 28.7 member may not be paid for opting out
In Step 28.8 Member may get food and beverage coupons in the device provide for free to public. Participating merchants, donor organizations as well as affluent public may contribute.
In Step 28.8 UH may manage the process and is paid for it

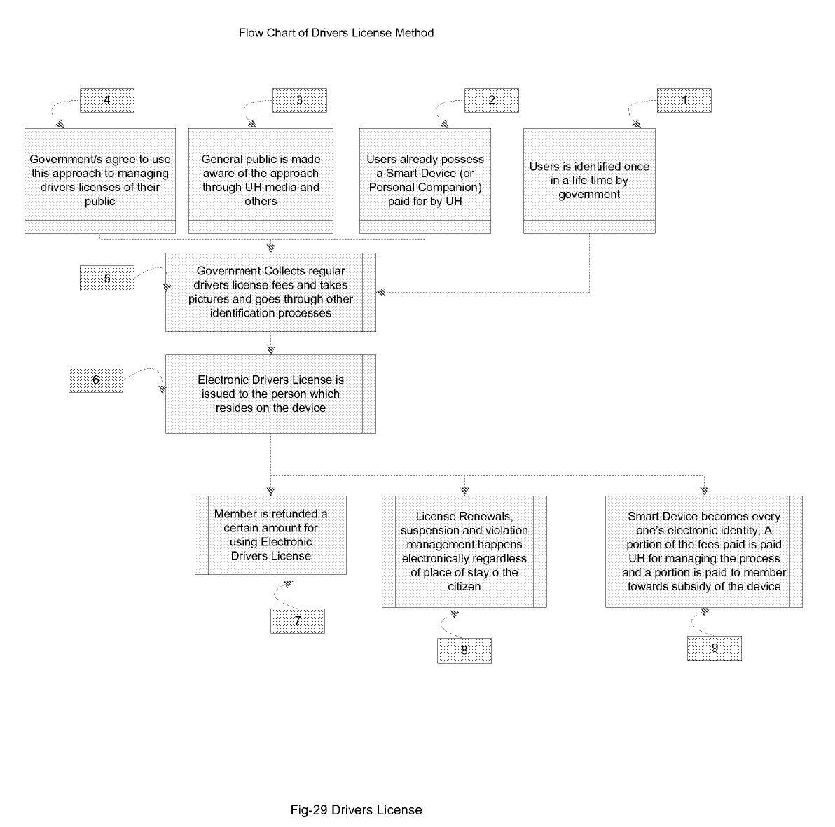

### FIG. 29 Illustrates Flow Chart of Driver's License App Method

Steps 29.1, 29.2 and 29.3 are analogous to the correspondingly numbered steps described in reference to FIG. 6 above
In Step 29.4 Government/s may agree to use this approach to managing driver's licenses of their public
In Step 29.5 Government/s may collect regular driver's license fees and may take pictures and go through other identification processes
In Step 29.6 Electronic Drivers License may be issued to the person. The license may reside on the device
In Step 29.7 member may be refunded a certain amount for using Electronic Drivers License
In Step 29.8 License Renewals, suspension and violation management may happen electronically regardless of place of stay o the citizen/member
In Step 29.9 The Device may become every one's electronic identity, A portion of the fees paid is paid to UH for managing the process and a portion may be paid to member towards subsidy of the free device

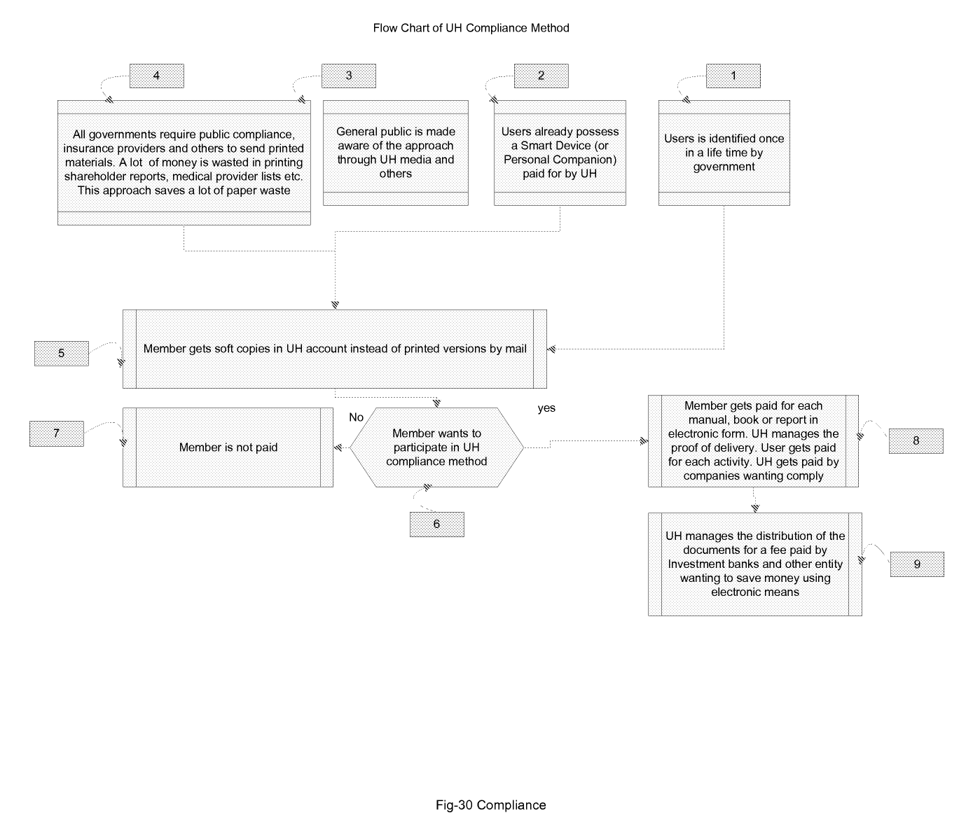

### FIG. 30 Illustrates Flow Chart of Compliance App Method

Steps 30.1, 30.2 and 30.3 are analogous to the correspondingly numbered steps described in reference to FIG. 6 above
In Step 30.4 governments may require public compliance by, insurance providers, Publicly Traded Companies and others to send printed materials to public. A lot of money is wasted in printing shareholder reports, medical provider lists etc. The UH approach may save a lot of paper and energy waste
In Step 30.5 member may get soft copies in UH account instead of printed versions by mail
In Step 30.6 member may decide to participate in UH compliance method
In Step 30.7 member may not be paid for opting out
In Step 30.8 member may get paid for downloading each manual, book or report in electronic form. UH may manage the proof of delivery. Member may get paid for each activity. UH may get paid by companies wanting to comply who may get real time feedback about the activity. Compliance reports may be used for submission to government agencies
In Step 30.9 UH may manage the distribution of the documents for a fee that may be paid by Investment banks and other entity who may want to save money using electronic means. Members may get subsidy towards free devic

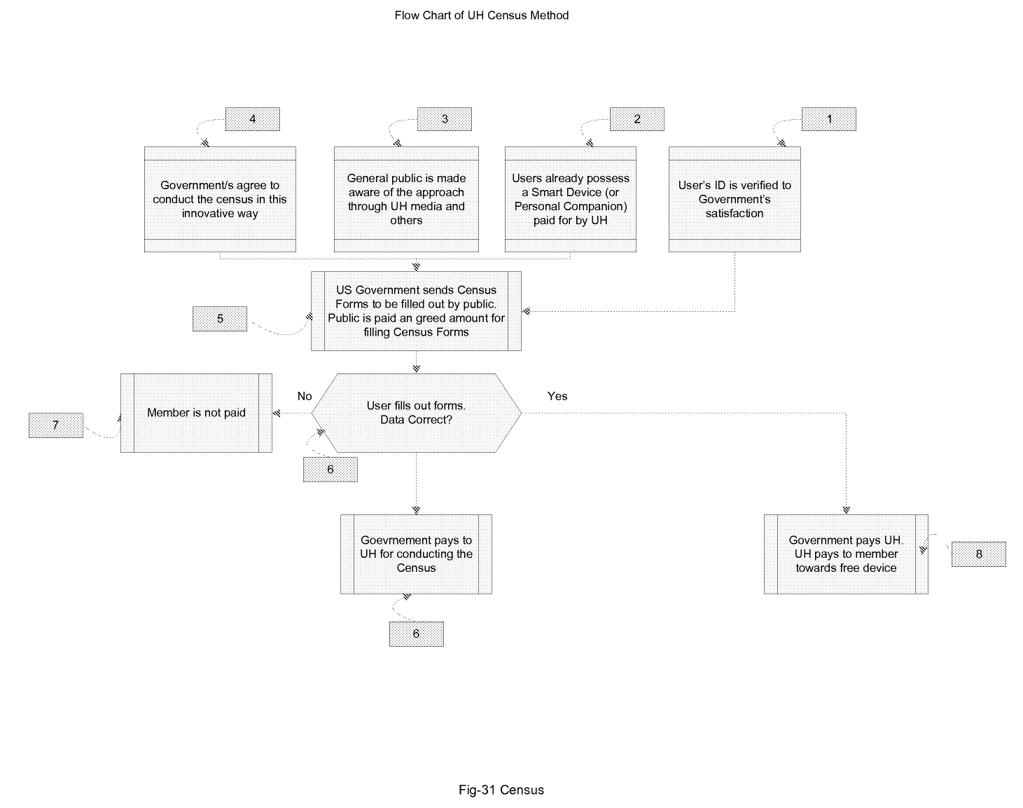

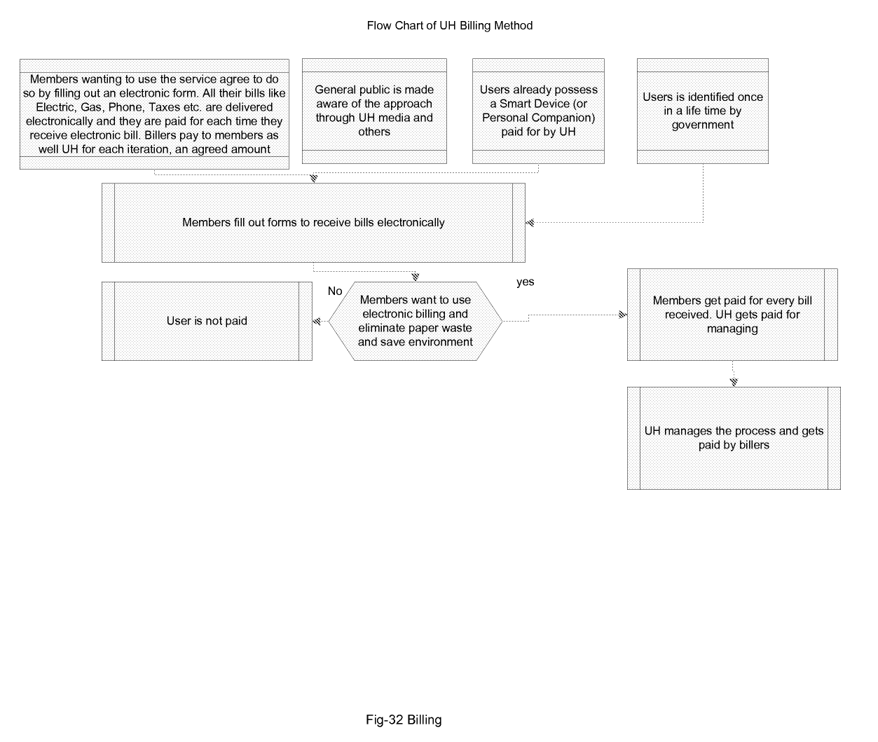

### FIG. 31 Illustrates Flow Chart of Census App Method

Steps 31.1, 31.2 and 31.3 are analogous to the correspondingly numbered steps described in reference to FIG. 6 above
In Step 31.4 government/s may agree to conduct the census in this innovative way
In Step 31.5 US (or any other) government may send Census Forms to be filled out by public. Public may be paid an greed amount for filling Census Forms
In Step 31.6 members may opt to fill out the form using the free device or Internet and ensures that data is correct
In step 31.7 member may not be paid for opting out or filling forms incorrectly
In Step 31.8 Government/s may pay to UH. UH may pay to member towards free device

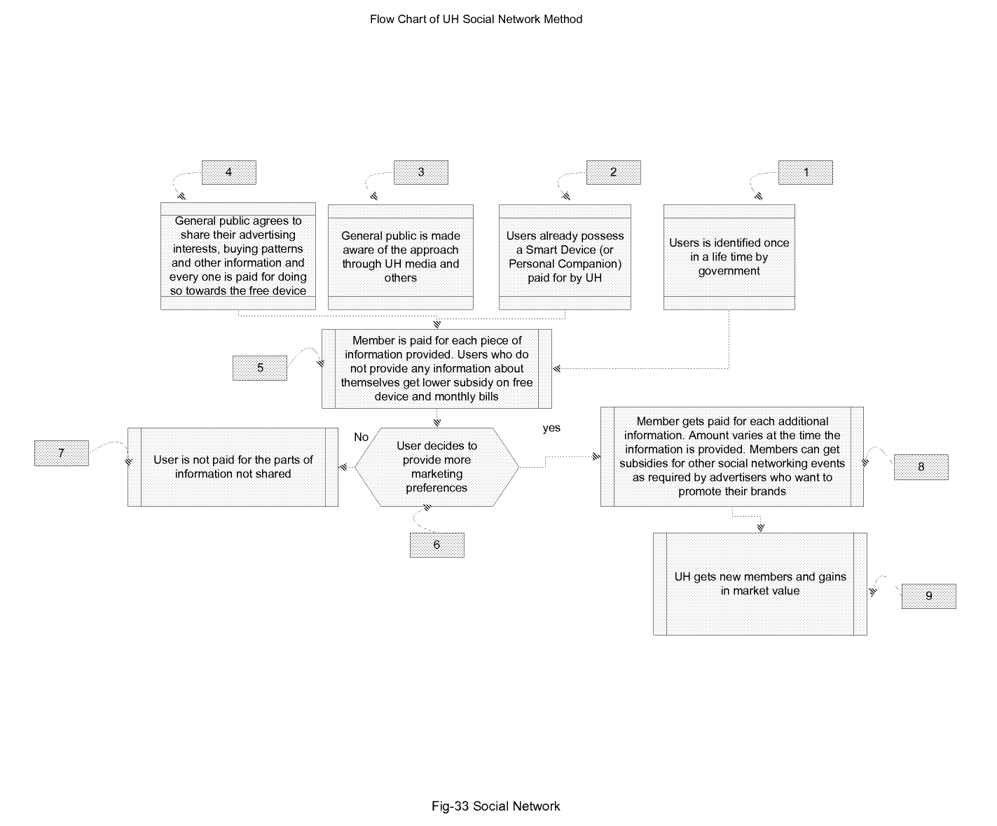

### FIG. 33 Illustrates Flow Chart of UH Social Network App Method

Steps 33.1, 33.2 and 33.3 are analogous to the correspondingly numbered steps described in reference to FIG. 6 above
In Step 33.4 general public may agree to share their advertising interests, buying patterns and other information and everyone may be paid for doing so towards the free device
In Step 33.5 member may be paid for each piece of information provided at the time of signing up. Members who may not provide any information about them may get lower subsidy on free device and monthly bills.
In Step 33.6 members may have the option to provide personal information or decline it
In Step 33.7 members who may decline to provide information may NOT be paid only for the relevant parts of information not shared
In Step 33.8 member may get paid for additional information. Amount may vary at the time the information is provided. Members may get subsidies for other social networking events as required by advertisers who may want to promote their brands
In Step 33.9 UH may get new members and may gain in market value of its shares for subsidizing the free device

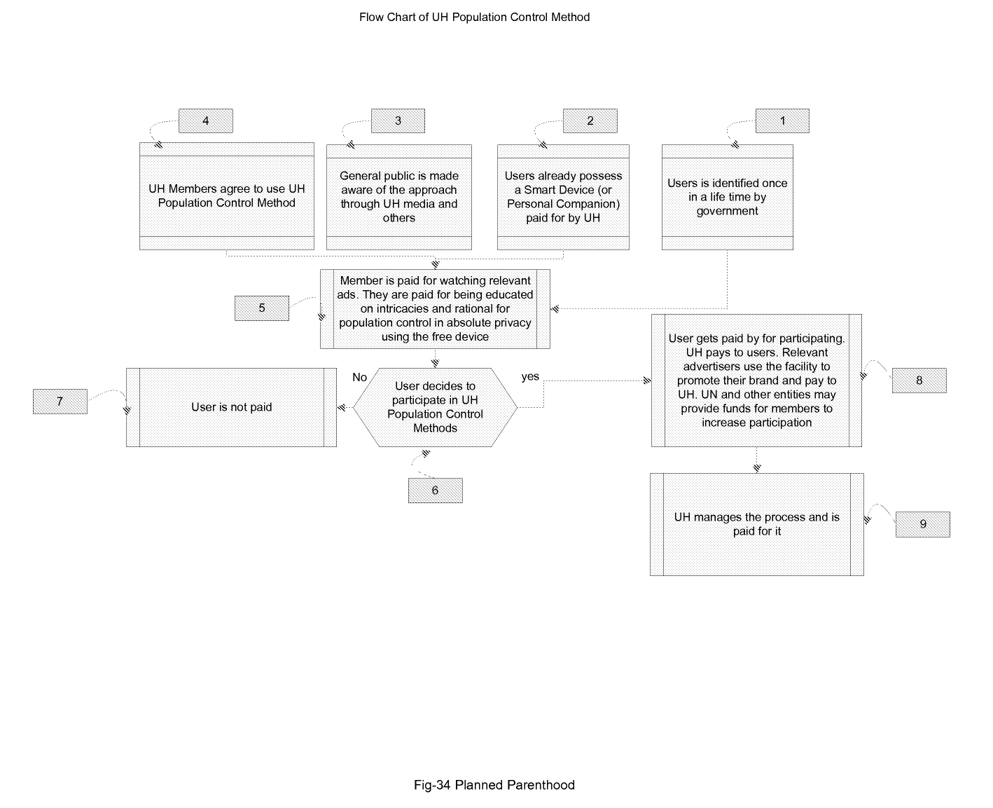

### FIG. 34 Illustrates Flow Chart of UH Planned Parenthood App Method

Steps 34.1, 34.2 and 34.3 are analogous to the correspondingly numbered steps described in reference to FIG. 6 above
In Step 34.4 UH members may agree to use UH Population Control Method
In Step 34.5 member may be paid for watching relevant ads of products and services that create awareness of the subject. They may be paid for being educated on intricacies and rational for population control in absolute privacy using the free device
In Step 34.6 members may decide to opt in or not
In Step 34.7 members may not be paid if they opt out
In Step 34.8 members may get paid by for participating. UH may pay to mambers. Relevant advertisers may use the facility to promote their brand and may pay to UH. UN and other entities may provide funds for members to increase participation
In Step 34.9 UH may manage the process and may be paid for it

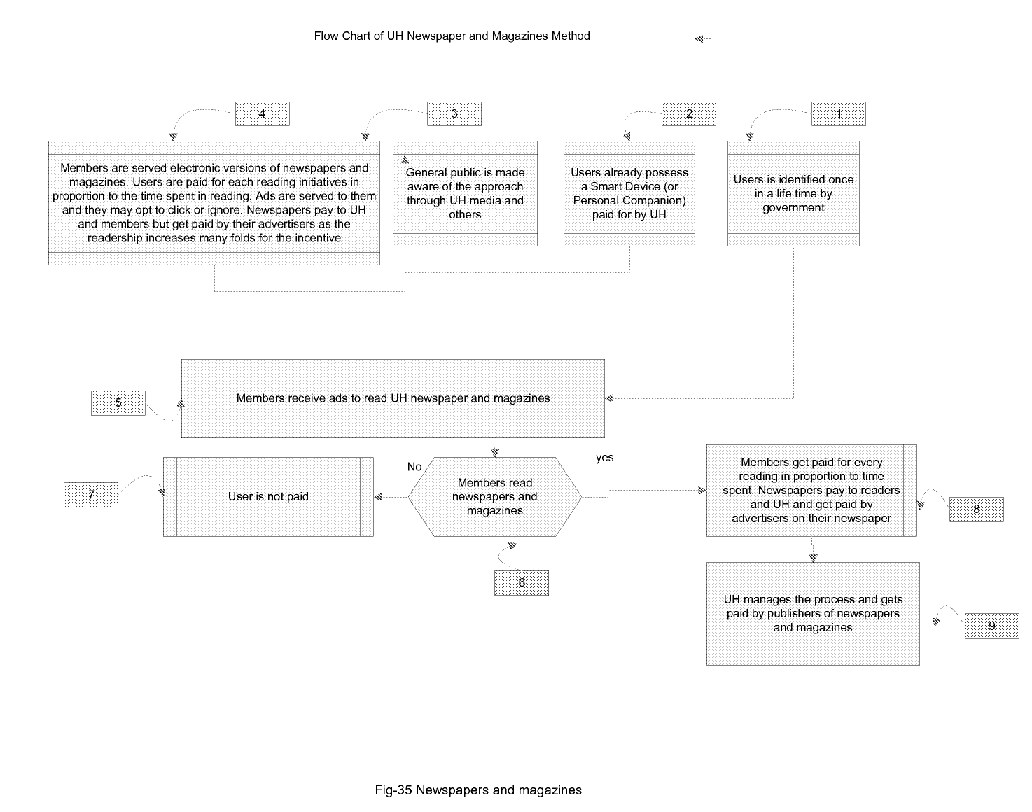

FIG. 35 Illustrates Flow Chart of UH Newspapers and Magazines App Method

Steps 35.1, 35.2 and 35.3 are analogous to the correspondingly numbered steps described in reference to FIG. 6 above
In Step 35.4 members may be served electronic versions of newspapers and magazines. Members may be paid for each reading initiatives in proportion to the time spent in reading. Ads may be served to them and they may opt to click or ignore. Newspapers may pay to UH and members but may get paid by their advertisers as the readership may increase many folds for the incentive
In Step 35.5 members may opt to read UH newspaper and magazines
In Step 35.6 members may opt out of the feature
In Step 35.7 members may not be paid if they have opted out
In Step 35.8 members may get paid for every reading in proportion to time spent. Newspapers pay to readers and UH and may get paid by advertisers on their newspaper
In Step 35.9 UH may manage the process and may get paid by publishers of newspapers and magazines

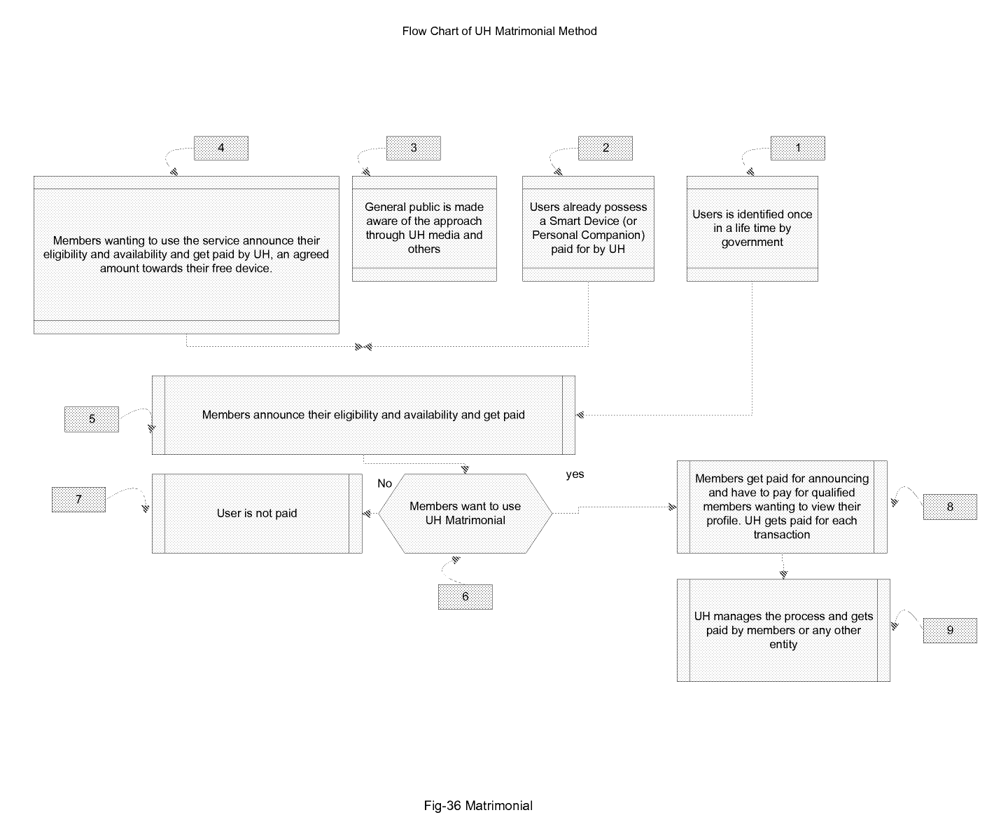

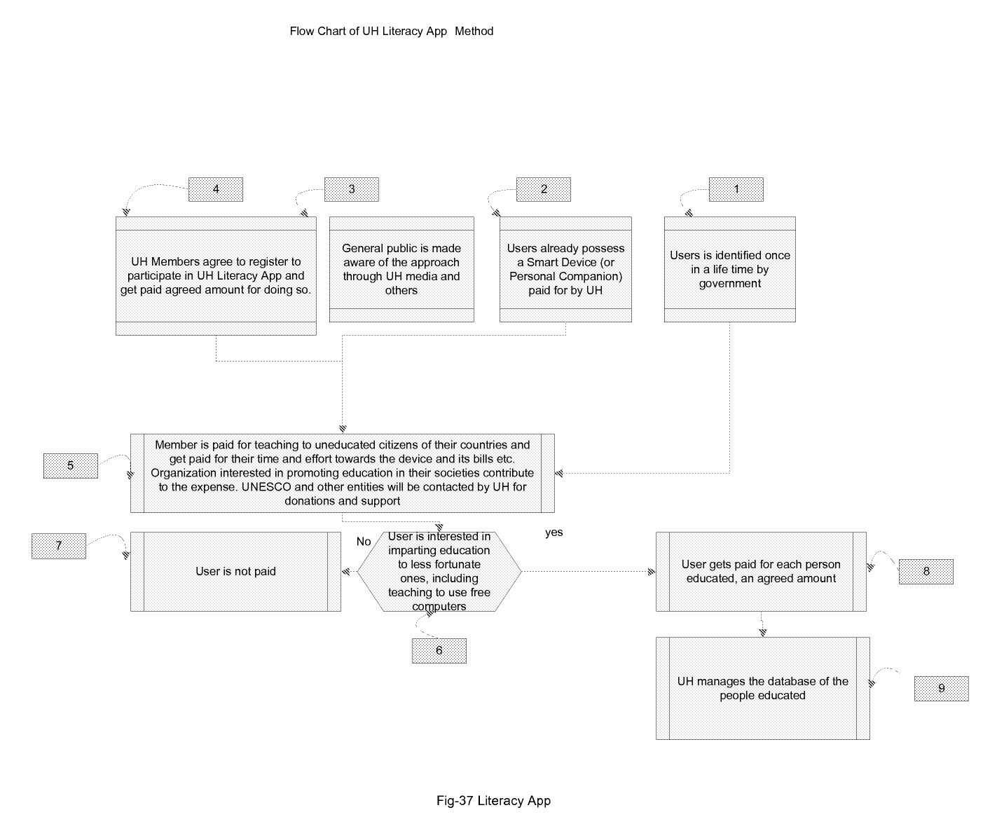

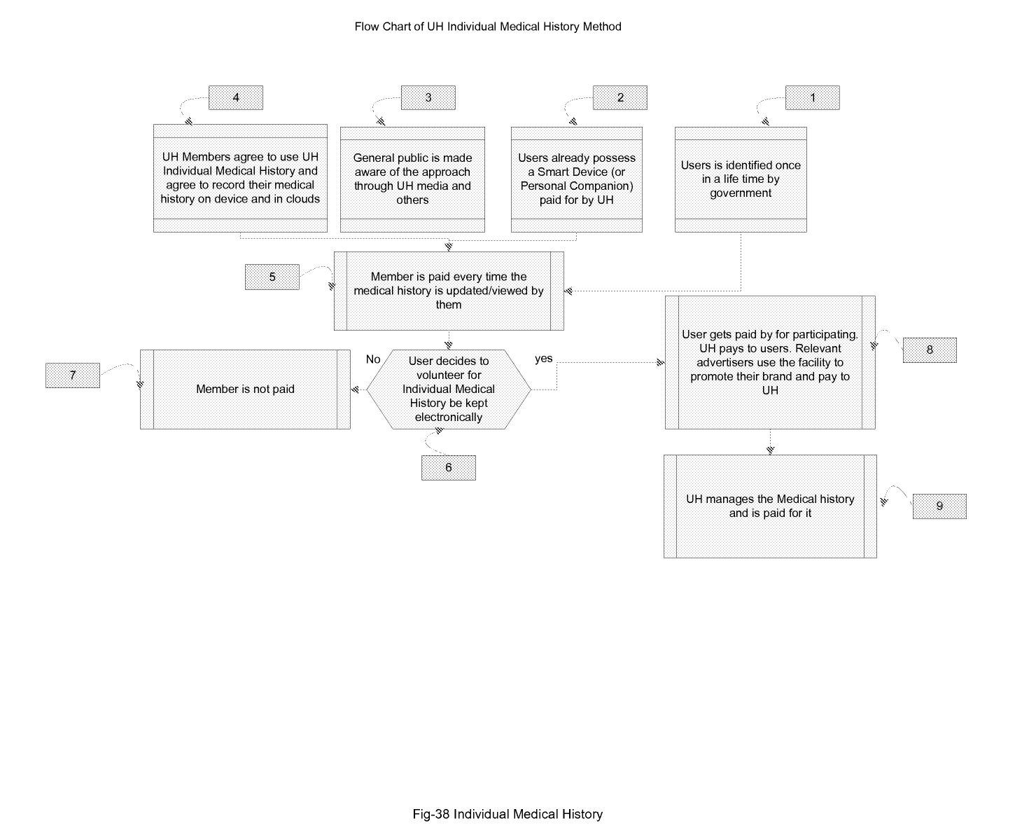

### FIG. 36 Illustrates Flow Chart of UH Matrimonial App Method

Steps 36.1, 36.2 and 36.3 are analogous to the correspondingly numbered steps described in reference to FIG. 6 above
In Step 36.4 Members wanting to use the service may announce their eligibility and availability and may get paid by UH, an agreed amount towards their free device.
In Step 36.5 Members may announce their eligibility and availability and get paid
In Step 36.6 members may decide to opt out if they want
In Step 36.7 members may not be paid if they opt out
In Step 36.8 Members get paid for announcing and have to pay for qualified members wanting to view their profile. UH gets paid for each transaction
In Step 36.9 UH manages the process and gets paid by members or any other entity

### FIG. 37 Illustrates Flow Chart of UH Literacy App Method

Steps 37.1, 37.2 and 37.3 are analogous to the correspondingly numbered steps described in reference to FIG. 6 above
In Step 37.4 UH members may agree to register to participate in UH Literacy App and may get paid an agreed amount for doing so.
In Step 37.5 member may be paid for teaching to uneducated citizens of their countries and may get paid for their time and effort towards the device and its bills etc. Organizations interested in promoting education in their societies contribute to the expense. UNESCO and other entities may be contacted by UH for donations and support
In Step 37.6 members may decide if they may be interested in imparting education to less fortunate ones, including teaching to use free computers
In Step 37.7 members may not be paid for opting out
In Step 37.8 member may get paid an agreed amount for each person educated. This may help spread education
In Step 37.9 UH may manage the database of the people educated

### FIG. 38 Illustrates Flow Chart of UH Medical History App Method

Steps 38.1, 38.2 and 38.3 are analogous to the correspondingly numbered steps described in reference to FIG. 6 above
In Step 38.4 UH members may agree to use UH Individual Medical History application and may agree to record their medical history on device and in clouds and may get paid for this activity
In Step 38.5 member may be paid every time their medical history is updated/viewed by them
In Step 38.6 member may decide to volunteer for Individual Medical History to be kept electronically. This may make him a potential target for advertising by medical service providers, who may not know the patient but can advertise based on his preferences and ailments. Advertisers may pay to the patient for his attention.
In Step 38.7 member may not be paid if they opt out
In Step 38.8 member may get paid by for participating. UH may pay to users. Relevant advertisers may use the facility to promote their brand and pay to UH.
In Step 38.9 UH may manage the medical history and may be paid for it. Medical history may be used for research purposes across globe

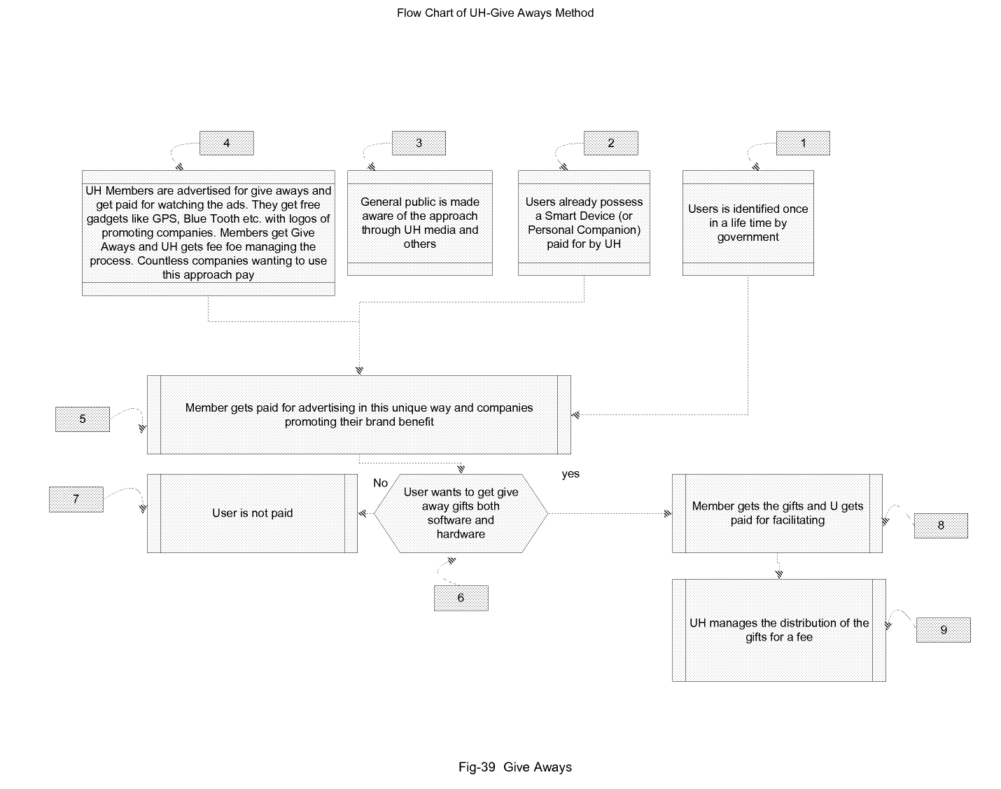

### FIG. 39 Illustrates Flow Chart of UH Give Aways App Method

Steps 39.1, 39.2 and 39.3 are analogous to the correspondingly numbered steps described in reference to FIG. 6 above
In Step 39.4 UH members may be advertised for give away gifts and they may get paid for watching the ads. They may get free gadgets like GPS, Blue Tooth etc. with logos of promoting companies. Members may get Give Away/s and UH may get fee for managing the process. Countless companies wanting to use this approach may pay to UH
In Step 39.5 member may get paid for advertising in this unique way and companies promoting their brand benefit
In Step 39.6 members may opt out
In Step 39.7 members may not be paid for opting out
In Step 39.8 member may get the gifts and UH gets paid for facilitating the brand. Examples may be that Coca Cola subsidizes GPS Application for the user and GPS may always display Coke's logo, reminding the member that Coke may be the donor for this great GPS application
In Step 39.9 UH may manage the process and may get paid for it

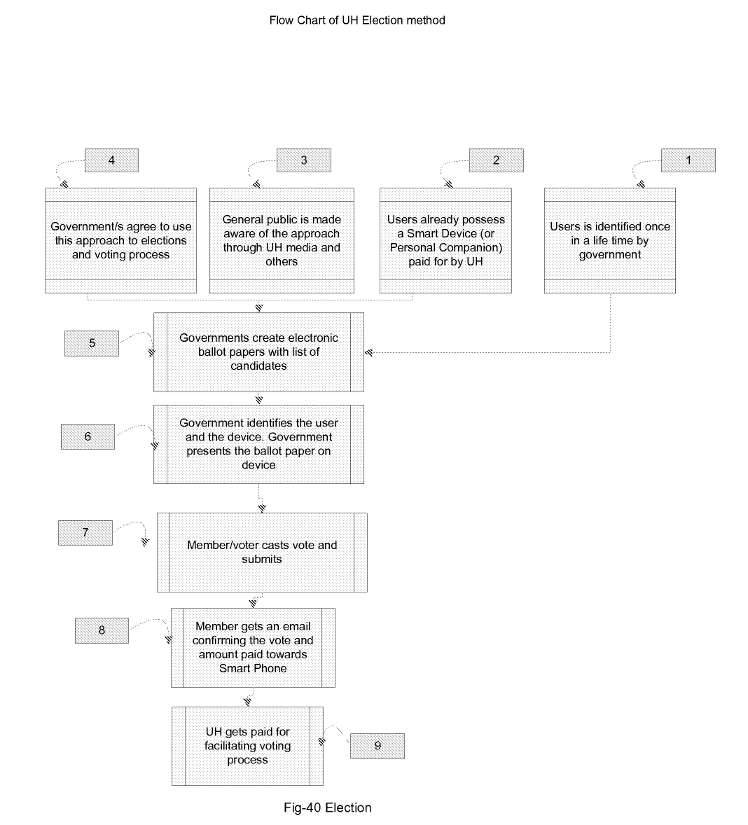

### FIG. 40 Illustrates Flow Chart of UH Elections App Method

Steps 40.1, 40.2 and 40.3 are analogous to the correspondingly numbered steps described in reference to FIG. 6 above
In Step 40.4 Government/s may agree to use this approach to elections and voting process
In Step 40.5 Governments may create electronic ballot papers with list of candidates
In Step 40.6 Government may identify the user and the device by photo, password etc. Government may present the ballot paper on device
In Step 40.7 member/voter may casts vote and may submit the vote electronically
In Step 40.8 member may get an email confirming that the vote might have been cast and amount may have been paid towards the device that facilitated electronic voting
In Step 40.9 UH may get paid for facilitating voting process

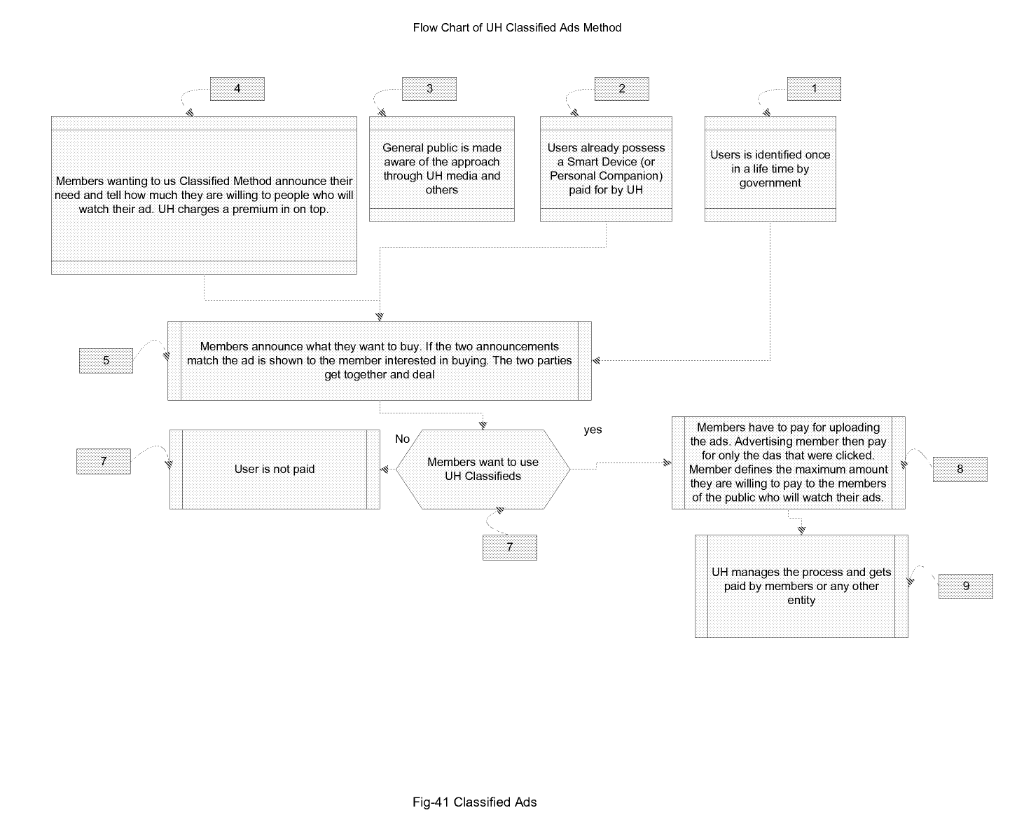

### FIG. 41 Illustrates Flow Chart of UH Classified Ads App Method

Steps 41.1, 41.2 and 41.3 are analogous to the correspondingly numbered steps described in reference to FIG. 6 above
In Step 41.4 members who may want to use Classified Method may announce their need and tell how much they are willing to pay people who may watch their ads. UH may charge a premium in on top.
In Step 41.5 members may announce what they want to buy. If the two announcements match the ad may be shown to the member interested in buying. The two parties may get together and deal
In Step 41.6 members may want to opt out
In Step 41.7 members who opt out may not be paid
In Step 41.8 members may have to pay for uploading the ads. Advertising member may then pay for only the das that were clicked. Member may define the maximum amount they may be willing to pay to the members of the public who may watch their ads.
In Step 41.9 UH may manage the process and may get paid by members or any other entity

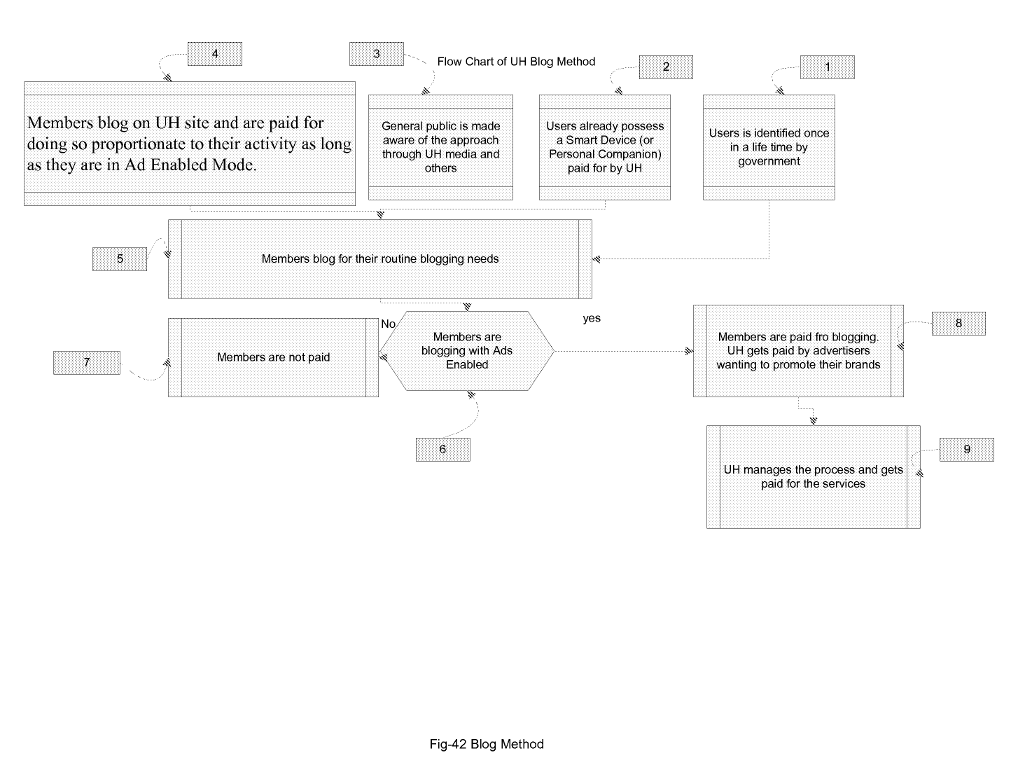

### FIG. 42 Illustrates Flow Chart of UH Blog App Method

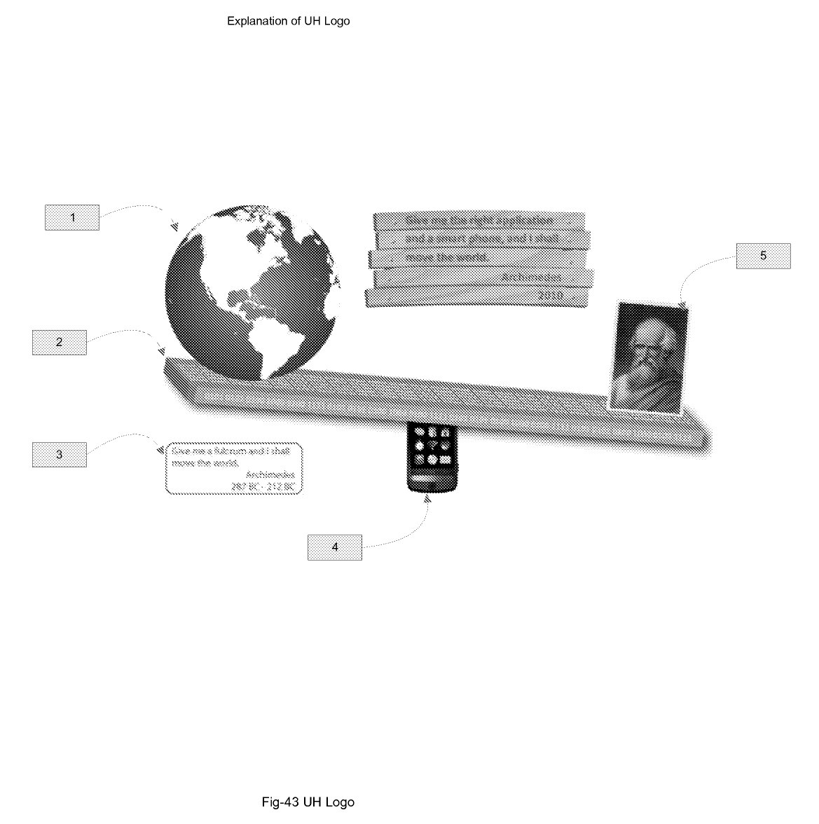

Steps 42.1, 42.2 and 42.3 are analogous to the correspondingly numbered steps described in reference to FIG. 6 above
In Step 42.4 Members may agree to use this approach to Blogging
In Step 42.5 Members may create Blogs on their favorite topics
In Step 42.6 Members may decide to Blog with advertising enabled
In Step 42.7 member may not be paid for opting out the mode that may enable payments
In Step 42.8 member may be paid for blogging and UH may be paid by advertisers
In Step 42.9 UH may get paid for facilitating the process
FIG. 43 is an illustration of UH Logo. The theme of the logo is that it may be possible to move the world like Archimedes stated centuries ago claiming ‘give me the fulcrum and I shall move the world’.

Inventors of the current device believe that owing to the explosive growth and penetration of Cell Phones and then Smart Phones across planet can and must be used to the advantage of humanity by making the Smart Phones free for all as these devices are smart enough to be programmed to become free or extremely cheap so that an average person in the world can afford it, thereby further dropping the price using mass purchasing advantages.

Now each step will be explained:
FIG.-43-1 The Globe or planet earth
FIG.-43-2 Software that will run on free devices and on central servers reaching all over the world
FIG.-43-3 Quote from Archimedes
FIG.-43-4 Smart Phone, being used as a pivot to move the world

### FIG.-43-5 Portrait of Archimedes

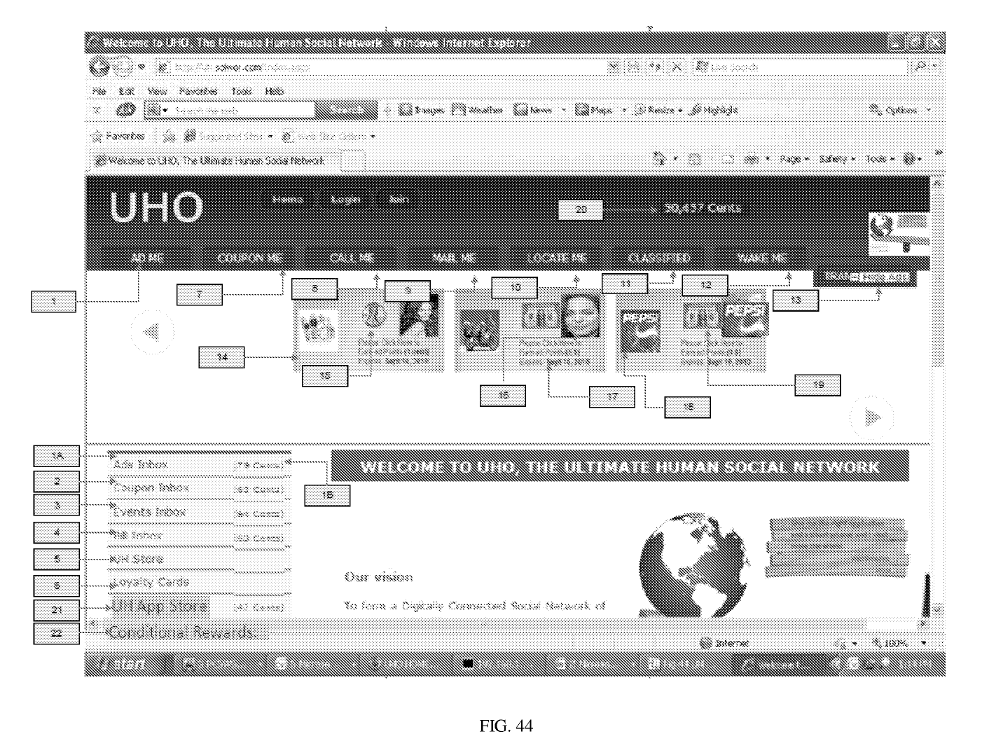

### FIG. 44 is an Illustration of UH Web Site.

The preferred embodiments of the UH Web Site will now be described with reference to the drawings. Note: There may be built-in checks and balances on each of the discussed features where members may only be paid once per ad or once in a given period of time, for clicking on ads. They may not click in quick succession to earn money that advertisers may not want to pay.
Step FIG.-44.1 Illustrates Ad Me button. This button can be clicked to invite ads from merchants. Merchants will advertise based on what kind of ad is being invited. For example a member may want to be advertised ‘Bicycles’ and that makes them an attractive audience to be advertised to. The ad becomes extremely targeted as it is being served when member wants to buy what they are looking for.
Step FIG.-44.1A illustrates ‘Ad Inbox’. This is like an ‘Email In-Box’ in concept. This may be a placeholder of relevant ads that may have been blocked by the user (in FIG.-44 step 13, which may be discussed later) while doing some productive work and did not want ads to interrupt. Step 1B indicates the sum of money that may be waiting to be paid to the member in Ad In-Box.
Step FIG.-44.2 is an illustration of ‘Coupon In-Box’. This is similar to Ad In-Box except that it may store Discount Coupons that manufacturers and retailers may have sent to the member while they may have been busy or may have used Ad Hide Button
Step FIG.-44.3 illustrates ‘Events In-Box’. This place holds ads of events that may pay the member for viewing them.
Step FIG.-44.4 illustrates Bills In-Box. This may be a placeholder for bills that may have been sent by billers of Electricity, Gas, Income Tax and others. The user may click, learn about the bill, may pay it and may save the money otherwise may have spent/wasted in paper billing
Step FIG.-44.5 illustrates UH Store. This may be the place where members may come and shop for any merchandise that UH may offer
Step FIG.-44.6 illustrates the clickable link to Loyalty Cards Application as explained earlier in this document.
Step FIG.-44.7 illustrates the clickable link to Coupon Me Application. Members may invite coupons for their favorite products or needed items. They get to explain the product or service that they need and coupons are served to them in real time based on their interest. They may be paid for downloading coupons to their devices
Step FIG.-44.8 illustrates the clickable link to Call Me Application. It may be very annoying when telemarketers may call in the middle of meetings etc. to sell their services or merchandise. This feature may enable members to let them be called by advertisers based on their ‘announcement’. For example if someone may be interested in refinancing their home then they may type ‘refinance’ and UH site may ask for their permission and the current number that they want called on. Telemarketers may immediately rush to offer money to be noticed. Member may click on offered ads and may select the best. It may be an extremely cost effective way as telemarketers may only be calling those who have shown interest relevant services.
Step FIG.-44.9 illustrates the clickable link to Mail Me. This is also another feature where member can request material to be sent to them based on their interest. For example Mail Me feature can be used to get printed copies of Parts Catalogs etc. if needed.
Step FIG.-44.10 illustrates the clickable link to Locate Me. Members may use this powerful feature when they may ‘want’ to be located by advertisers. For example a family wanting to find a restaurant in the area they may be visiting may use this feature. Based on their current location, advertisers may rush to offer their services and pay the member for viewing their offer. Member may click on multiple ads before deciding to dine at a given place.
Step FIG.-44.11 illustrates the clickable link to Classified Ads. A member who may want to buy, say, a car may click on this link and may be given opportunity to enter details of their needs. Other members or advertisers may offer their ads with the money payable for clicking their ads. Member may click on selected few ads and may buy based on their free choice. Advertisers may pay fraction of the cost that may be incurred in advertising on other media as only interested parties may interact with each other.
Step FIG.-44.12 illustrates the clickable link to Wake Me App. This may be the only alarm clock in the world that may wake up members and may pay them every time they wake up. Members may wake up at the time they set to the sound an advertisement. Advertisers mat be very interested in waking people up to their message at a reasonable cost to them. Members may be interested in using this as they may never have seen an alarm clock that may pay them every morning.
Step FIG.-44.13 illustrates the clickable link to Hide Ads. This button may enable members to work on the site and all the visible ads disappear but may start going to relevant ads In-boxes. The ads are served based on member's buying, clicking and ‘ad inviting’ patterns and interests that they may have shown at the time of signing up.
Step FIG.-44.14 illustrates what is also a clickable link to the site/page of the advertiser. If member may be interested to watch the ad then they may click on one of the ad banners shown and that may take to the site/page of the advertiser who may have just paid them for clicking a known amount:
Ad Banner may also have following attributes:

It may be any shape, color or size

It may be static or moving.

It may change its attributes while waiting to be clicked on (in Ad In-box etc.)

It may kill itself if not viewed or otherwise felt that conditions are not conducive for it to exist.

It may multiply if needed. It may move between ad boxes or it may be forwarded.

It may be recalled. It may be tagged for later viewing etc. It may be commented on and returned by user. It may be ‘Forced’ to be viewed or member may have to pay if not viewed in a given date range.

Step FIG.-44.15 illustrates that the member can see how much money the advertiser may be willing to pay them for clicking on the ad and interacting with it. In this case member may be paid 10 Cents in their account. The amount may vary based on the member's history of buying behavior based on UH assessment and advertiser's budget.
Step FIG.-44.16 illustrates the picture of the person who may have sent the ad, provided it was a forwarded ad.
Step FIG.-44.17 illustrates the expiring date of the ad. The ads may disappear after they are no longer valid or they may change the offer in real time, making it possible for advertisers to change the messages even after the ads have left the servers.
Step FIG.-44.18 illustrates the clickable link to the advertiser who may be paying for watching or clicking on the ad.
Step FIG.-44.19 illustrates the clickable link to a bigger amount that some advertisers may want to pay based on next activity performed. For example a bank may offer 10 Cents to watch their ad but $150 for opening an account with them through UH web site
Step FIG.-44.20 illustrates the clickable link to the amount that a member may have earned by clicking and interacting with ads. If a member wants an explanation of their earnings then they may click here for details.
Step FIG.-44.21 illustrates the clickable link to the UH App Store
Step FIG.-44.22 illustrates the clickable link to the Conditional Rewards
In this App the member may get an offer to watch an ad (say for example 5 Cents but promises to refund (say) $5 on real purchase). The member may click, and may get 5 Cents and then $5 becomes accrued with a recorded commitment from the seller that the member may get $5 towards the device provided the deal happened in the allotted time. The offer, if not clicked on, may disappear from the device. Another example may be of the perishable food items that have known expiry date. The merchant has to return to the manufacturer if the item/s are not sold by the expiry date. Both merchants and manufacturers may face penalties if items are sold after expiry date. In this application businesses with the knowledge of such items (like Ice Cream, Milk, Yogurt, Bread etc.) may use UH Conditional Rewards App and may have the option of rushing to buy the product and be rewarded towards the free device and its gadgets etc. All merchandise is sold on time and huge waste of food is avoided.
Members may like this highly rewarding feature and merchants can use this feature to attract buyers in slow times. UH gets rewarded in the process. Members may get subsidy to the free device.

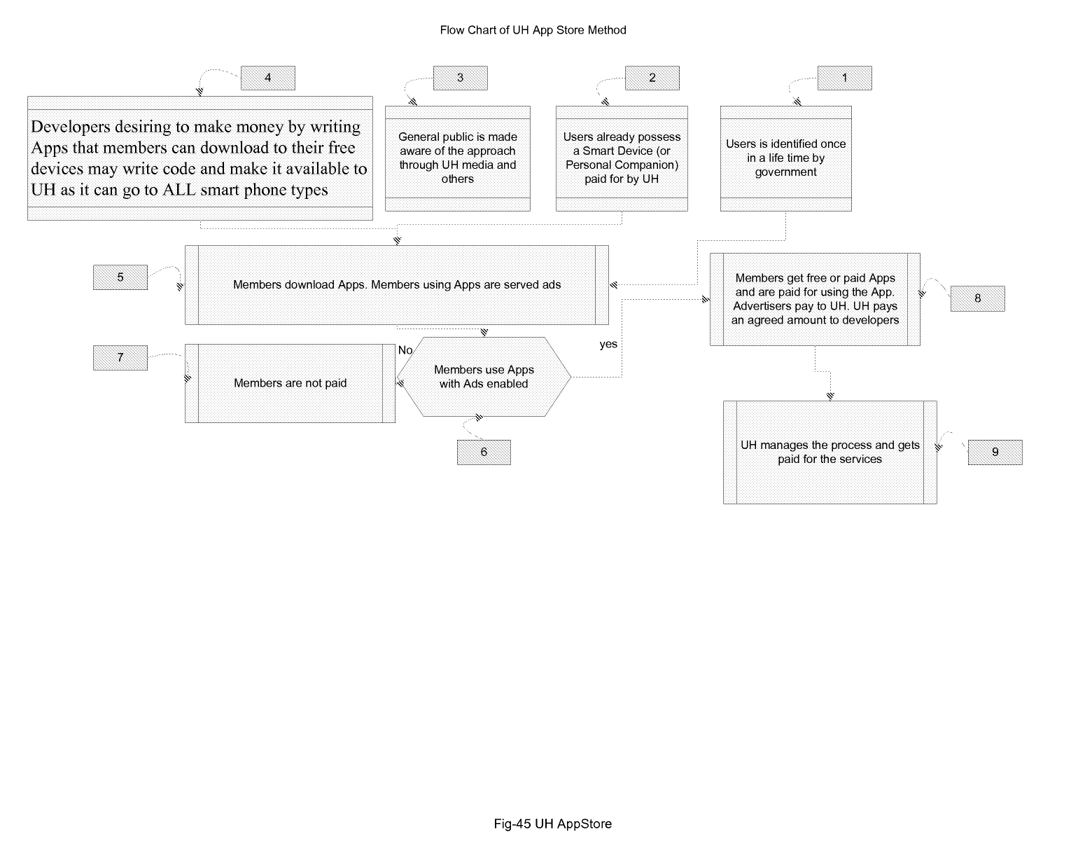

### FIG. 45 Illustrates Flow Chart of UH App Store Method

Steps 45.1, 45.2 and 45.3 are analogous to the correspondingly numbered steps described in reference to FIG. 6 above
In Step 45.4 developers who may want to use UH APP Method may announce their App availability and may tell how much they are willing to pay people who want their App loaded. The amount may be small but will still be an innovative approach to build clients who use these Apps.
In Step 45.5 members may opt to take a look at the offered Apps for being rewarded. They may download Apps to their devices and may get paid. Members then start using the Apps of their liking
In Step 45.6 members may want to opt out
In Step 45.7 members who opt out may not be paid
In Step 45.8 members get free or paid Apps and are paid for using the App. Advertisers may pay to UH based on agreed click through rates. UH may pay an agreed amount to developers
In Step 45.9 UH may manage the process and may get paid by members or any other entity

Although the invention above has been described primarily in terms of advertising being the dominant funding source, one of ordinary skill in the art will readily appreciate that other sources may be used, such as, but not limited to, charity donations or carbon credit based funding.

For instance a user may be provided free of charge with a smart phone that may have modules and attachments such as, but not limited to, a GPS module, a digital camera and a camera operating module;

A user may then use the smart phone to send a server a request to operate an application, along with a user identifier.

The smart phone may then obtain relevant parts of the requested application from the server. The smart phone may then display an appropriate graphic related to the application, along with one or more reimbursable mode options. These reimbursable mode options may include options such as, but not limited to, a charity mode option, an advertising mode option and a carbon micro-credit mode option, or some combination thereof.

The user may then use the smart phone to select one of the reimbursable modes or they may select prefer to pay mode option.

If one of said reimbursable mode options is selected, the user may, on using the application, see an electronic notification of a monitory credit to an account associated with them, received and displayed by the smart phone.

In this way a user may receive compensation for using a smart-phone application.

The charitable mode reimbursement may, for instance, be part of a tax deductable charity donation made by an ordinary citizen in a more developed country to a person in a less developed country in return for using an educational application such as, but not limited to, a literary program, a math educational program, or merely for accessing information from, or providing information to, an educational source such as, but not limited to, the Wikipedia. A relatively small donation by a person in a developed country may be a considerable amount for a person in a developing country. A person in a developed country may, for instance, make a single donation that may then be split into a number of “micro” charity donations and distributed among a number of cell phone users.

The carbon credit mode reimbursement may, for instance, be applicable if the cell phone user is participating in some project, such as, but not limited to, accessing an electronic directory or service, thereby saving C02 emissions on the production of paper, or the act of distribution. The project may receive some or all of its funding via carbon credit trading with a developed nation corporation. As part of the carbon credit trade, all or part of that funding may be required to be shared with the participants in the project. This may, for instance, be done by providing micro- carbon credit rewards to each cell phone participant based on, for instance, their participation in the project.

When displaying the reimbursable mode options, the cell phone may also display a monetary value associated with each of said reimbursable mode options for using that service, or performing that activity.

The cell phone may also help provide user identification by, for instance, providing a current GPS location of the user and/or a current image obtained using the digital camera. That current image may be a biometric identifier such as, but not limited to, a picture of the user's face or a picture of a user's thumb print.

As seen from the perspective of the server, the method would appear as follows:

The server may receive a request to operate an application from a smart phone. The smart phone may be equipped with a module of an applications such as, but not limited to, a GPS module, a digital camera and a camera operating module.

Along with the request for an app, the server may receive a user identifier, that may be a current GPS location of the user and/or a current image obtained using the digital camera. That current image may be a biometric identifier such as, but not limited to, a picture of the user's face or a picture of a user's thumb print.

Based on information about the identified user such as, but not limited to, relevant demographic data and their current location, the user, and the requested application, may be qualified as to eligibility for a variety of reimbursable modes such as, but not limited to, a charity mode reimbursable option, an advertising mode reimbursable option, and a carbon micro-credit mode reimbursable option;

The server may then send an offer to select from one of the qualified reimbursable options to the user's cell phone.

If one of the reimbursable mode options is selected by the user, the server, on receiving notification of that selection from the smart phone, and of an appropriate level of use of the application by the user, the server may then identify at least one provider of funding for the selected reimbursable mode, and send to the user via the smart phone, a conditions of reimbursement statement. These conditions may, for instance, be spending a certain amount of time on an education application, or obtaining a certain grade on a testable educational module.

On receipt of notification that the conditions have been fulfilled, the server may then transfer a monetary credit from an account associated the funding provider to an account associated with the identified user. The server may also send an electronic notification of the monitory credit to the account associated with the identified user to the user's smart phone.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1: A method of receiving compensation for use of a smart-phone application, comprising:
providing a smart phone having a GPS module, a digital camera and a camera operating module;
sending by said smart phone to a server a request to operate an application, and a user identifier;
obtaining and displaying, by said smart phone, relevant parts of said application and one or more reimbursable mode options, said reimbursable mode options comprising a charity mode option and at least one reimbursable mode option selected from an advertising mode option and a carbon micro-credit mode option;
selecting one of said reimbursable modes or selecting a prefer to pay mode option 178; and
if one of said reimbursable mode options is selected, on using said application, receiving and displaying by said smart phone, electronic notification of a monitory credit to an account associated with said identified user.

2: The method of claim 1 wherein said displaying said reimbursable mode options further comprises displaying a monetary value associated with each of said reimbursable mode options.

3: The method of claim 1 wherein said user identifier further comprises a current GPS location and a current image obtained using said digital camera.

4: The method of claim 3 wherein said application is a census application.

5: The method of claim 1 wherein said application is one of a social network app., a blood donor app, an opinion polls app, a social network app., an organ donor registration app., a planned parenthood app., a credit card app., an SOS volunteers registration app., a driving license app., an idea app., a criminal hunt app., a missing children app., an education app., a literacy app., a worldwide democracy app., a workout app., and a United Human Organization app.

6: A method of receiving compensation for use of a smart-phone application, comprising:
receiving from a smart phone having a GPS module, a digital camera and a camera operating module, a request to operate an application and a user identifier;
qualifying said requested application and said identified user for eligibility for a charity mode reimbursable option, an advertising mode reimbursable option, and a carbon micro-credit mode reimbursable option;
sending to said smart phone, an offer to select from said qualified reimbursable options and a prefer to pay option;
if one of said reimbursable mode options is selected, on receiving notification from said smart phone, of a use of said application, identifying at least one provider of funding for said selected reimbursable mode, and sending to said smart phone a conditions of reimbursement statement;
on receipt of a fulfillment of said conditions of reimbursement notification, transferring a monetary credit from an account associated with said at least one provider of funding for said selected reimbursable mode to an account associated with said identified user; and
sending an electronic notification of said monitory credit to said account associated with said identified user to said smart phone.
